(19) United States
(12) Patent Application Publication
(10) Pub. No.: US 2013/0218978 A1
(43) Pub. Date: Aug. 22, 2013

(54) Systems and Methods for Project Collaboration in a Cloud Computing Environment

(71) Applicant: Numira Biosciences, (US)

(72) Inventors: David Weinstein, Salt Lake City, UT (US); William Martin, Salt Lake City, UT (US); Neha Shah, Salt Lake City, UT (US); Jeroen Stinstra, Salt Lake City, UT (US)

(73) Assignee: Numira Biosciences, Salt Lake City, UT (US)

(21) Appl. No.: 13/771,009

(22) Filed: Feb. 19, 2013

Related U.S. Application Data
(60) Provisional application No. 61/600,472, filed on Feb. 17, 2012.

(51) Int. Cl. H04L 29/06

(52) U.S. Cl. CPC H04L 65/403
USPC 709/205

(57) ABSTRACT

A method for project collaboration includes: at a computer system, hosting a collaboration software application and a plurality of data sets associated with the collaboration software application; establishing a first remote user session between the computer system and a first client device running on a first operating system; wherein the first client device is associated with a first user; establishing a second remote user session between the computer system and a second client device running on a second operation system, distinct from the first operating system; wherein the second client device is associated with a second user distinct from the first user; merging the first remote user session and the second remote user session into a single remote user session; and enabling, using the single remote user session, the first user and the second user to concurrently control the collaboration software application and the plurality of data sets.

### TECHNICAL FIELD

The present application relates generally to systems and methods for project collaboration in a cloud computing environment.

### BACKGROUND

Contract research organizations (CROs) play a growing role in the medical diagnostic fields, life science research, and for those that are developing new pharmaceuticals or medical devices. Rather than attempting to internally support the often complex services provided by such groups, users can rely on the expertise of the CRO. This saves time and expense and often results in better study results.

Examples of the types of studies run by CROs include, but are not limited to, high-resolution quantitative imaging, drug dosing studies in small animals, cell analysis, and other general laboratory services. During the performance of these services, a CRO communicates frequently with their client. This communication usually takes the form of email, in-person interviews, web meetings, phone conferences, and paper-based correspondence. In advance of the project, the CRO uses email and phone meetings to understand the client's project goals and to define the CRO's role in the study. During the course of a study, the CRO will have phone and web-meetings with the client to present intermediate results and to provide an opportunity for the client to refine how their analyses and deliverables are tailored.

At the conclusion of a study, imaging data sets and other study data that are generated during the performance of the services provided to the client by the CRO are transferred to the client via, for example hard drives that are shipped to the client, or via a secure link to the CRO's server that is provided to the client. Upon receipt, the client will review both the written and raw data, perform additional analysis, store the data in file cabinets, desks, or internal servers, and, at some date in the future, attempt to find the data in order to compare it to other data for additional information.

Beyond accessing and viewing data sets, there is a need for clients to enter annotations, comments, indicators, questions, or other such non verbal communications to be linked to a client's data set and incorporated into a client's project. It is not uncommon for a project to have several collaborators located not only in different laboratories, but in different areas of the world. The methods by which a client can share the data amongst themselves have drawbacks. For instance, consider the case in which two researchers, working for the client that are not in the same building, or are at different worksites altogether, desire to review data that has been received from the CRO. In such instances, the researchers must go through a cumbersome and time-consuming exercise of agreeing on where the data is to be stored, and how they will review the data in a collaborative way. The above-identified process is repeated for each study in which not only the CRO participates, but with services from other third-party providers as well. Therefore, there is a need for a centralized location for users to access remotely from different locations to view and comment on data sets in a particular project. A CRO frequently fields questions and comments from clients about their data and the status of projects in progress. A large part of these communications center around questions, comments, and discussions in regard to the data generated from the client's specimens or samples.

Another drawback with conventional systems and methods of reporting project data based on CRO work is that there is not currently a system in place at most CRO sites that allows for a client to independently track the progress of their study or the sample processing that is being performed by the CRO. Normally, a client does not have access to or the ability to view individual samples as they are finished processing by the CRO, but rather the collection of samples are viewed at the conclusion of a project. This has the drawback of preventing the client to ascertain how well a project is going until at points in time determined by the client's needs. For example, the client may need to report to an investor or upper management on the progress of an ongoing project. Without real time access to the data as it is being processed, the client is unable to effectively meet these reporting demands.

Given the above background, improved interfaces for reviewing data provided by a testing laboratory to remote clients is needed.

### SUMMARY

The present disclosure addresses the shortcomings found in the prior art. In the present disclosure a server computer system is provided that comprises one or more processing units, and a memory, coupled to at least one of the one or more processing units, the memory storing a virtual machine. A runtime system runs within the virtual machine. The runtime system is executed by at least one of the processing units. The runtime system comprising instructions for providing any combination of the following features: (i) providing a home page that provides details of a plurality of projects associated with a first user, (ii) providing an overview panel for a project, selected from the plurality of projects by the first user, the overview panel detailing a plurality of samples associated with the project, (iii), providing a data analysis panel for the selected project, the data analysis panel comprising a plurality of measurements for each sample in the plurality of samples associated with the project, (iv) providing a visual analysis panel for the selected project, the visual analysis panel including a plurality of objects associated with the selected project, (v) providing a discussion/notes panel for the selected project, the discussion/notes panel including notes associated with objects in the plurality of objects, (vi) providing a gallery panel for the selected project, for reviewing content that is associated with the selected project, and (vii) providing a live meeting panel for a selected project, where the live meeting panel comprises a whiteboard that is configured to be viewed by any user associated with the selected project, where any user associated with the project that is viewing the whiteboard can drag objects associated with the selected project onto the whiteboard and can annotate the whiteboard.

In some implementations, a method for user collaboration includes: at a computer system, hosting a collaboration software application and a plurality of data sets associated with the collaboration software application; establishing a first remote user session between the computer system and a first client device running on a first operating system; wherein the first client device is associated with a first user; establishing a second remote user session between the computer system and a second client device running on a second operation system, distinct from the first operating system; wherein the second client device is associated with a second user distinct from the first user; merging the first remote user session and the second remote user session into a single remote user session; and enabling, using the single remote user session, the first user and the second user to concurrently control the collaboration software application and the plurality of data sets.

In some implementations, the collaboration software application comprises a whiteboard application, and the plurality of data sets includes one of: audio files, video files, image files, 3D images, charts, tables, or data grids.

In some implementations, the plurality of data sets comprises histology data sets.

In some implementations, the method also includes preparing for concurrent display from a plurality of angles, a three-dimensional object represented in a three-dimensional image.

In some implementations, the method also includes adjusting a display of the three dimensional object from a first angle in the plurality of angles, without user intervention, in accordance with a change to a display of the three dimensional object from a second angle in the plurality of angles.

In some implementations, the method also includes preparing for display, in the collaboration application, status indicators for the first and second users.

In some implementations, the method also includes enabling the first and second users to concurrently access a plurality of projects using the collaboration software application.

In some implementations, the method also includes preparing for display a representation of a count of users having access to a project in the plurality of projects.

In some implementations, the method also includes preparing for concurrent display a data set in the plurality of data sets in a first visual representation, and a second visual representation distinct from the first visual representation.

In some implementations, the first visual representation is a grid view, and the second visual representation is a chart view.

In some implementations, the method also includes recording access history for a respective user in the first or second user.

In some implementations, the method also includes obtaining an update to the plurality of data sets, and in response to the update, preparing for display, to the first and second users, a second plurality of data sets in accordance with the first plurality of data sets and the update.

In some implementations, a computer system comprising: one or more processing units; one or more programs including instructions, configured to be executed by the one or more processing units, for: hosting a collaboration software application and a plurality of data sets associated with the collaboration software application; establishing a first remote user session between the computer system and a first client device running on a first operating system; wherein the first client device is associated with a first user; establishing a second remote user session between the computer system and a second client device running on a second operation system, distinct from the first operating system; wherein the second client device is associated with a second user distinct from the first user; merging the first remote user session and the second remote user session into a single remote user session; and enabling, using the single remote user session, the first user and the second user to simultaneously control the collaboration software application and the plurality of data sets.

In some implementations, the collaboration software application comprises a whiteboard application, and the plurality of data sets includes one of: audio files, video files, image files, 3D images, charts, tables, or data grids.

In some implementations, the plurality of data sets comprises histology data sets.

In some implementations, the one or more programs further comprise instructions for preparing for concurrent display from a plurality of angles, a three-dimensional object represented in a three-dimensional image.

In some implementations, the one or more programs further comprise instructions for automatically adjusting a display of the three dimensional object from a first angle in the plurality of angles, without user intervention, in accordance with a change to a display of the 3D object from a second angle in the plurality of angles.

In some implementations, the one or more programs further comprise instructions for preparing for display, in the collaboration application, status indicators for the first and second users.

In some implementations, the one or more programs further comprise instructions for enabling the first and second users to concurrently access a plurality of projects using the collaboration application.

In some implementations, the one or more programs further comprise instructions for preparing for display a representation of a count of users having access to a project in the plurality of projects.

In some implementations, the one or more programs further comprise instructions for preparing for concurrent display a data set in the plurality of data sets in a first visual representation, and a second visual representation distinct from the first visual representation.

In some implementations, the first visual representation is a grid view, and the second visual representation is a chart view.

In some implementations, the one or more programs further comprise instructions for recording access history for a respective user in the first or second user.

In some implementations, the one or more programs further comprise instructions for obtaining an update to the plurality of data sets, and in response to the update, preparing for display, to the first and second users, a second plurality of data sets in accordance with the first plurality of data sets and the update.

In some implementations, a non-transitory computer readable storage medium storing one or more programs, the one or more programs comprising instructions, configured to be executed by a computer system with one or more processors, for: hosting a collaboration software application and a plurality of data sets associated with the collaboration application; establishing a first remote user session between the computer system and a first client device running on a first operating system; wherein the first client device is associated with a first user; establishing a second remote user session between the computer system and a second client device running on a second operation system, distinct from the first operating system; wherein the second client device is associated with a second user distinct from the first user; merging the first remote user session and the second remote user session into a single remote user session; and enabling, using the single remote user session, the first user and the second user to concurrently control the collaboration software application and the plurality of data sets.

In some implementations, the collaboration software application comprises a whiteboard application, and the plurality of data sets includes one of: audio files, video files, image files, 3D images, charts, tables, or data grids.

In some implementations, the plurality of data sets comprises histology data sets.

In some implementations, the one or more programs further comprise instructions for preparing for concurrent display from a plurality of angles, a three-dimensional object represented in a three-dimensional image.

In some implementations, the one or more programs further comprise instructions for automatically adjusting a display of the three dimensional object from a first angle in the plurality of angles, without user intervention, in accordance with a change to a display of the 3D object from a second angle in the plurality of angles.

In some implementations, the one or more programs further comprise instructions for preparing for display, in the collaboration application, status indicators for the first and second users.

In some implementations, the one or more programs further comprise instructions for enabling the first and second users to concurrently access a plurality of projects using the collaboration application.

In some implementations, the one or more programs further comprise instructions for preparing for display a representation of a count of users having access to a project in the plurality of projects.

In some implementations, the one or more programs further comprise instructions for preparing for concurrent display a data set in the plurality of data sets in a first visual representation, and a second visual representation distinct from the first visual representation.

In some implementations, the first visual representation is a grid view, and the second visual representation is a chart view.

In some implementations, the one or more programs further comprise instructions for recording access history for a respective user in the first or second user.

In some implementations, the one or more programs further comprise instructions for obtaining an update to the plurality of data sets, and in response to the update, preparing for display, to the first and second users, a second plurality of data sets in accordance with the first plurality of data sets and the update.

### BRIEF DESCRIPTION OF THE DRAWINGS

FIG. 1 illustrates a view of a system in accordance with some embodiments of the present disclosure.

FIG. 2 illustrates another view of the system in accordance with some embodiments of the present disclosure.

FIG. 3 illustrates a log in screen for a runtime system in accordance with some embodiments of the present disclosure.

FIG. 4 illustrates a home page for a project detailing a list of projects, and for each respective project in the list, (i) brief summary information, including direct links to most important documents, and (ii) an overview of recent project activity (e.g. project updates, questions/discussions) available to registered users through push notifications, e-mails, etc. in accordance with some embodiments of the present disclosure.

FIG. 5 illustrates a visual analysis panel for a plurality of objects, where the visual analysis panel supports various document types and process types for the objects (e.g., image types, movie types, applications) and includes badges that indicate where there are notes associated with data and further includes recent project activity (project updates, questions/discussions) that is available as push notifications, emails, etc., in accordance with some embodiments of the present disclosure.

FIG. 6 illustrates a visual analysis panel in which the selection of a first object type causes objects of the first object type that are associated with the project to drop into a lower frame of the visual analysis panel in accordance with some embodiments of the present disclosure.

FIG. 7 illustrates the selection of an object of the first object type from the visual analysis panel of FIG. 6, resulting in the opening of a first light-box for the object, a movie, in accordance with some embodiments of the present disclosure.

FIG. 8 illustrates the visual analysis panel in which the selection of a second object type causes objects of the second object type that are associated with the project to drop into a lower frame of the visual analysis panel in accordance with some embodiments of the present disclosure.

FIG. 9 illustrates the selection of an object of the second object type from the visual analysis panel of FIG. 8, resulting in the opening of a second light-box for the object, a histological image, in accordance with some embodiments of the present disclosure.

FIG. 10 provides an illustration of how an object can be annotated in a dataset associated with a project, where such annotations are linked to the discussion/notes page associated with a project and such annotations can be pushed to subscribers in accordance with some embodiments of the present disclosure.

FIG. 11 illustrates the selection of an object of an third object type from the visual analysis panel and the running an application to render the selected object on a remote server, in which display features can be toggled on and off in accordance with some embodiments of the present disclosure.

FIG. 12 illustrates the statistical treatment of data associated with a project using tools available in the runtime system thereby generating plot in accordance with some embodiments of the present disclosure.

FIG. 13 illustrates how statistical plots may be viewed directly from the runtime system in accordance with some embodiments of the present disclosure.

FIG. 14 illustrates how a comparative analysis of various selected datasets associated with a project may be done in accordance with some embodiments of the present disclosure.

FIG. 15 illustrates how the comparative analysis depicted in FIG. 14 may be opened using a comparison tab of the runtime system in accordance with some embodiments of the present disclosure.

FIG. 16 illustrates a discussion/notes board associated with a project in accordance with some embodiments of the present disclosure.

FIG. 17 illustrates a gallery associated with a project in accordance with some embodiments of the present disclosure.

FIG. 18 illustrates a live meeting in which project members can (i) drag objects associated with a project onto and off of a common white board viewable by all project members and (ii) annotate the objects and/or the white board in accordance with some embodiments of the present disclosure.

FIG. 19 illustrates a project dashboard, which shows a synopsis of various projects hosted by the runtime system in accordance with some embodiments of the present disclosure.

FIG. 20 illustrates a reference library, which shows information regarding procedure used to generate data for various projects hosted by the runtime system and other information relevant to such projects in accordance with some embodiments of the present disclosure.

FIG. 21 illustrates an upload interface for uploading data associated with a project hosted by the runtime system in accordance with some embodiments of the present disclosure.

Like reference numerals refer to corresponding parts throughout the several views of the drawings.

### DETAILED DESCRIPTION

The present disclosure addresses the drawbacks identified in the background section. Disclosed is a cloud-based runtime system having remote access. As such, a user need not run the applications or software needed to review data produced by a testing laboratory on their own local computer system. As used herein, the term “cloud”, means both public clouds (e.g. AMAZON and MICROSOFT clouds), as well as private clouds, which typically reside in a company's own data center (e.g. some biotech, pharmaceutical, medical device and/or diagnostic companies have their own private cloud in their local data center, which employees of the respective companies access from their desktops). Cloud application services, also known as software as a service (SaaS), provide access to software applications running remotely over the Internet, eliminating the need for the user to install and run the application on their local computer. Cloud platform services, also known as platform as a service (PaaS), deliver a computing platform and/or solution stack as a service, which requires consuming cloud infrastructure and sustaining cloud applications.

A feature of the runtime systems of the present disclosure is that all computing and data storage occurs remotely in the cloud, and the user interacts with their data through their local desktop computer, iPad, or other mobile device. This eliminates the need for users to download, install, or learn all the complexities of the software implemented by the CRO. This concept—using a cloud framework to dramatically simplify the process of running and linking existing applications—is an advantageous feature of the disclosed runtime system.

Organization and varied views. Once logged in, the user can navigate to various views, features, tabs, and modules of the runtime system. In some embodiments, the runtime system includes a dashboard, a project overview, specimen details or information, relational views or spatial correspondence, statistical analysis, side-by-side comparisons, discussion/notes, a reference library, an electronic lab notebook, a virtual whiteboard, project management overview, a gallery, document management, profile management, auditing (provenance tracking, access controls, etc.), or a subset or a superset of these features.

In some embodiments, the runtime system supports a freeform investigation mode. In this mode, the user freely moves through various analytic tools, probing, dissecting, and aggregating the data as they explore. As they move through the different steps and tools, the runtime system tracks their history and parameters, and an interface is provided both for reviewing that history, as well as for going back and making modifications to specified parameters or tool selections.

Data organization. Another feature of the runtime system of the present disclosure is the ability to organize and manage large collections of data files. The runtime system provides the underlying infrastructure and user-interface components for tagging, grouping, and hierarchically organizing data. The runtime system allows for complex metadata tags, which encode information about how a dataset was created (e.g., equipment, operator, protocol, date, etc.), as well as project data (e.g., project number, specimen number, grouping information, etc.), with the history defining how a dataset has been processed (e.g., scripts, parameters, associated input and output datasets, operator, date, etc.). In some embodiments, the runtime system also supports annotations to datasets; examples of annotations include, but are not limited to text and drawing primitives (e.g., boxes, circles, arrows, curves, etc.). The runtime system stores the annotations as metadata as well as who created the annotations, when they created the annotations, and what data objects they were seeing when they created the annotations. In some embodiments, the runtime system support cross-links, which are metadata pointers that explicitly associate objects in one dataset with objects in other datasets, or that associate objects within the same dataset. The runtime system provides user interface views and widgets to support the creation, viewing and, where appropriate, editing of all of these metadata tags. Similarly, the runtime system provides user-interface elements for organizing and grouping datasets.

Integration with other applications. In some embodiments, the runtime system uses software developed by the CRO. In such instances, a user of the runtime system gains access to such software. In some embodiments, in addition to the software developed by the CRO, the runtime system makes use of software developed by vendors other than the CRO. Advantageously, in order to fully make use of the tools needed to review data, a user buys a subscription to the runtime system and thus gets access to the full array of software tools, including those provided by the CRO and third party vendors. In this way, the user does not have to purchase the servers, software, data-center space or network equipment, needed to run the full array of tools needed to analyze the data hosted by the runtime system. This obviates the need for users to download, install, operate, and manage the numerous applications the runtime system employs to view and analyze the user data sets. By integrating and leveraging this suite of applications within the runtime system, the runtime system of the present disclosure allows for users to easily retrieve, view, manipulate, analyze and process their data.

Whiteboard.

To address the communication drawbacks of the prior art methods and systems, the runtime system incorporates a virtual whiteboard to allow users to drop data onto the white board, and enter comments, calculations, graphs, etc. The whiteboard sessions are saved and archived by the runtime system and, moreover, users of the runtime system can email these saved sessions to each other. For example, a user can obtain an image of a specimen from within a project hosted by the runtime system, and drop the image onto the whiteboard, along with charts, statistical analysis, and specimen information, and then add annotations or pose questions on the whiteboard. The whiteboard session is then saved, and other users can then view the save session and also add annotations or comments.

Real-Time Tracking.

To the CRO laboratory and its users, the runtime system allows users to track the progress of their project. Using the runtime system, the user is able to access and view data sets as each sample is completed and uploaded to the runtime system.

Controlled Access and Credentials.

In some embodiments, a user can log into the platform via an internet website and thereby have access to restricted and unrestricted applications and data sets based upon the user's credentials. Individuals can subscribe to various projects, and thereby receive push notifications when information is added to the runtime system, whether they are data, comments, annotations, etc.

Data Analysis and Archiving.

In some embodiments, a user is able to complete computations and analysis tasks in the cloud, not on the user's local computer system. This allows for faster processing of the requisite computations. For example, a user could view the images of several specimens under a comparison feature, decide to analyze the cortical roughness of the samples, and then set a batch of samples to be processed, all within the cloud. As such, the runtime system provides a centralized source for all information, data, processing, progress, communications, and analysis for a user's projects.

The disclosed runtime system is suitable for the needs of any contract research organization in the biotechnology field, and is able to combine the databases of several contract research organizations into a single project hosted by the runtime system. More generally, the disclosed runtime system is useful in fields outside of life sciences. In one embodiment, the runtime system provides a cloud-based tool, coupled with thin client applications, that integrates management, processing, analysis, tracking, and communication about project data. Such a runtime system finds applicability in a broad spectrum of fields.

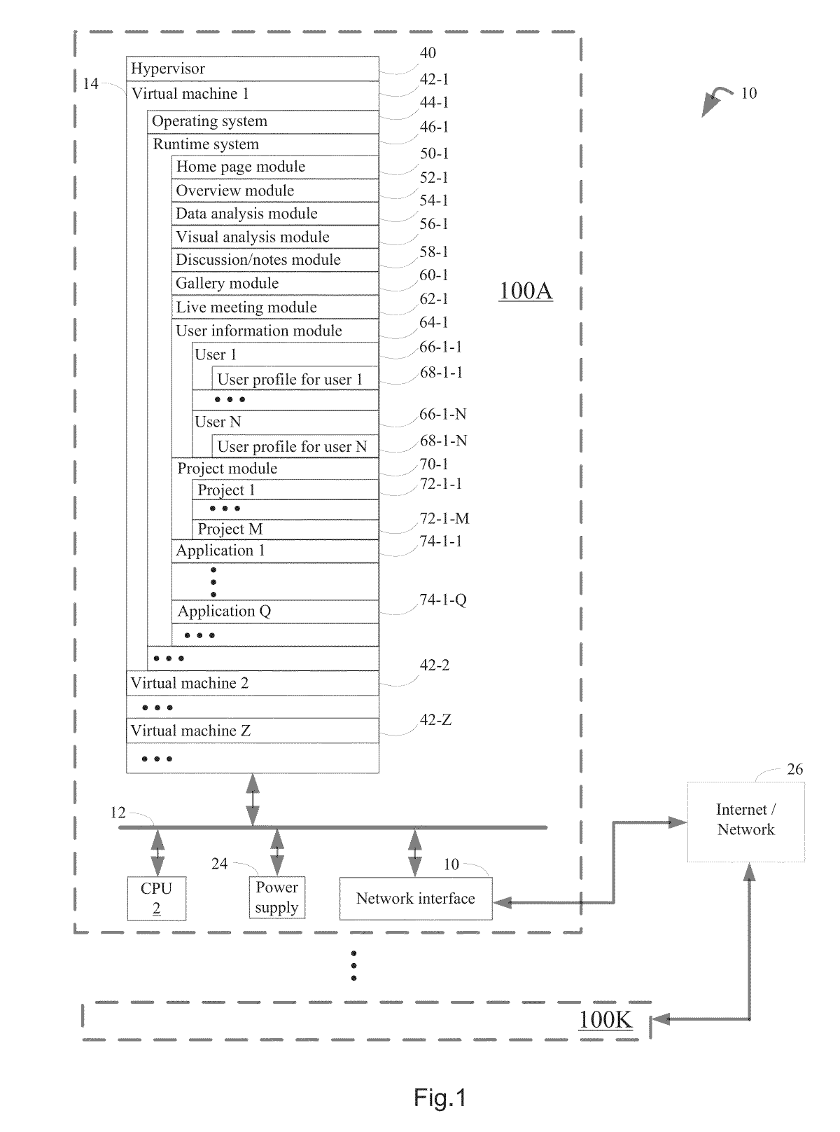

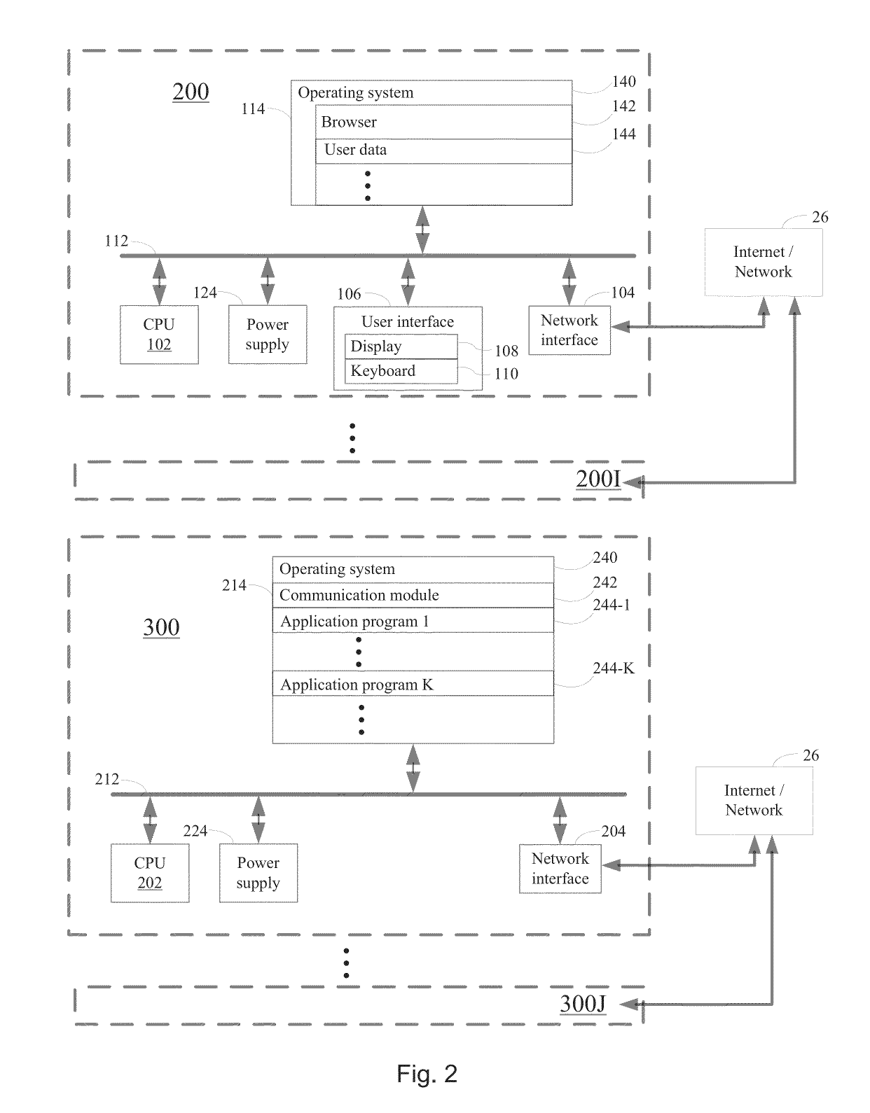

Now that an overview of the features of the runtime system have been disclosed, a detailed description of a system topology 10 in accordance with the present disclosure is described in conjunction with FIGS. 1 and 2. In the topology, there is one or more server computers 100 hosting virtual machines (FIG. 1), one or local client systems 200 (FIG. 2) and, optionally, one or more back-end servers 300 (FIG. 2). Of course, other topologies are possible, for instance, there may be any number of server computers like that of the server computer 100 collectively functioning in the same manner as the server computer 100. Moreover, more typically, there are tens, hundreds, or even thousands of local client systems 200 or more. Also, optionally, there can be any number of backend servers 300. The exemplary topology shown in FIGS. 1 and 2 merely serves to describe the features of an embodiment of the present disclosure in a manner that will be readily understood to one of skill in the art.

The server computer 100 will typically have one or more processing units (CPU's) 2, a network or other communications interface 10, a memory 14, one or more communication busses 12 for interconnecting the aforementioned components, and a power supply 24 for powering the aforementioned components. The communication busses 12 may include circuitry (sometimes called a chipset) that interconnects and controls communications between system components. Memory 14 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 14 optionally includes one or more storage devices remotely located from the CPU(s) 2. Memory 14, or alternately the non-volatile memory device(s) within memory 14, comprises a non-transitory computer readable storage medium. Memory 14 can include mass storage that is remotely located with respect to the central processing unit(s) 2. In other words, some data stored in memory 14 may in fact be hosted on computers that are external to the server computer 100 but that can be electronically accessed by the server computer 100 over an Internet, intranet, or other form of network or electronic cable (illustrated as element 26 in FIG. 1) using network interface 10.

In some embodiments, Memory 14 stores a hypervisor 40 for initiating hardware virtual machines 42 and one or more hardware virtual machines 42. There may be any number of hardware virtual machines 42 running on the server computer 100. In some instances, there is only one hardware virtual machine 42 running on the server computer 100. In some instances, there are two or more, three or more, five or more, or ten or more hardware virtual machines 42 running on the server computer 100. In some instances, a single virtual machine 42 is running on multiple server computers 100. Each respective hardware virtual machine 42 preferably comprises: an operating system 44 that includes procedures for handling various basic system services and a runtime system 46.

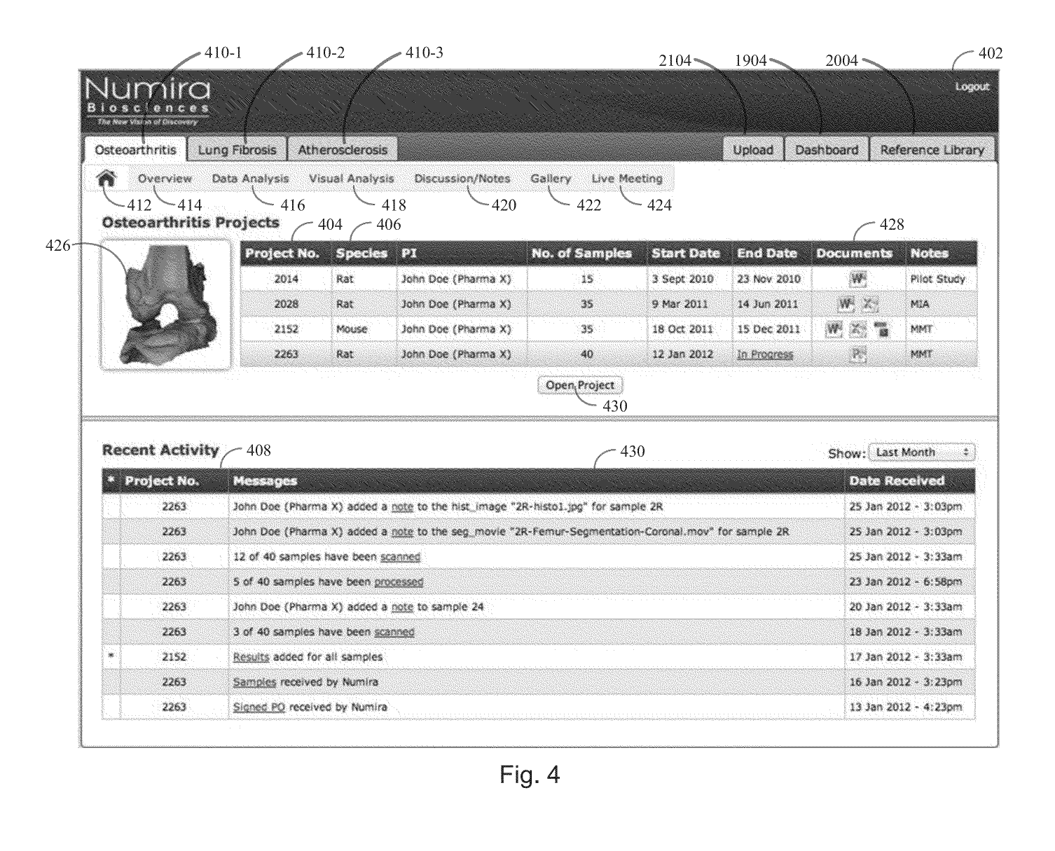

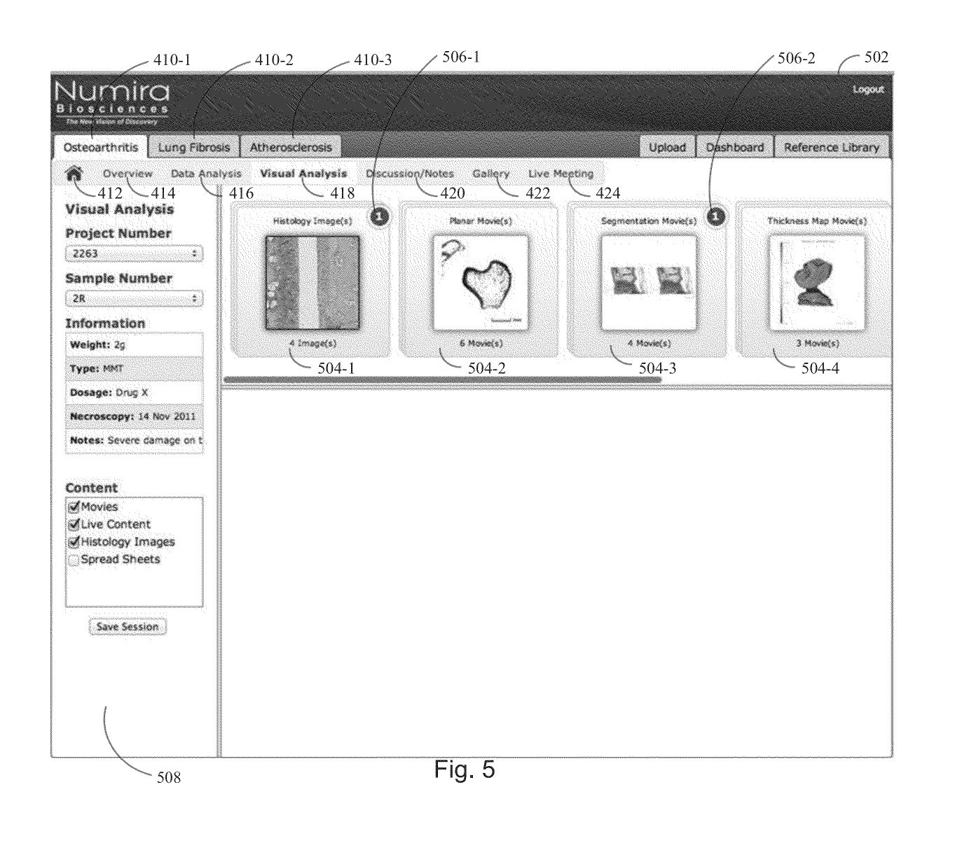

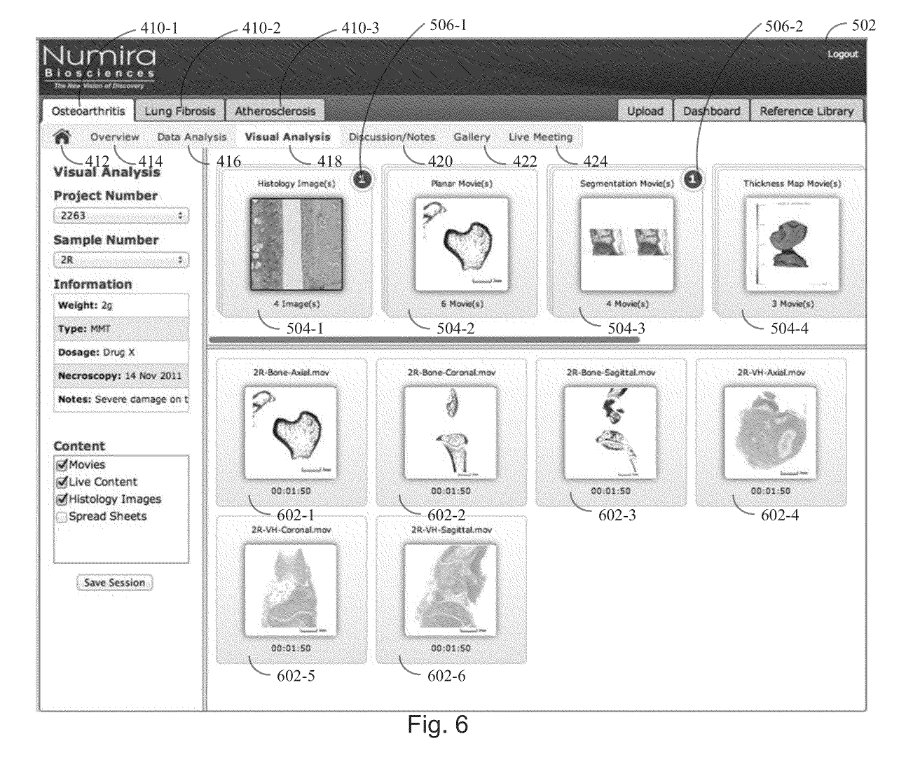

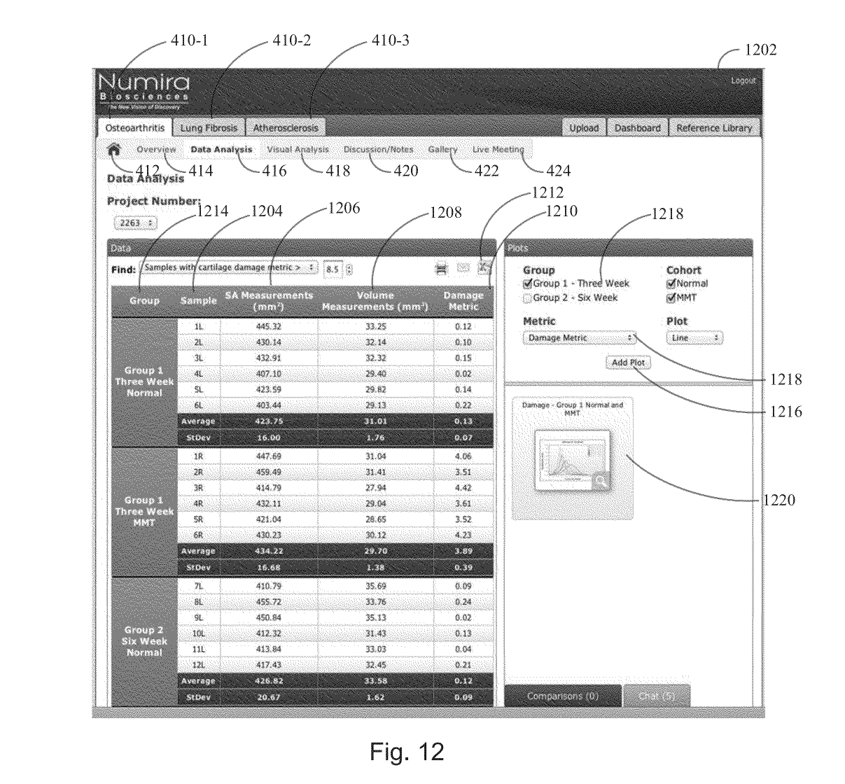

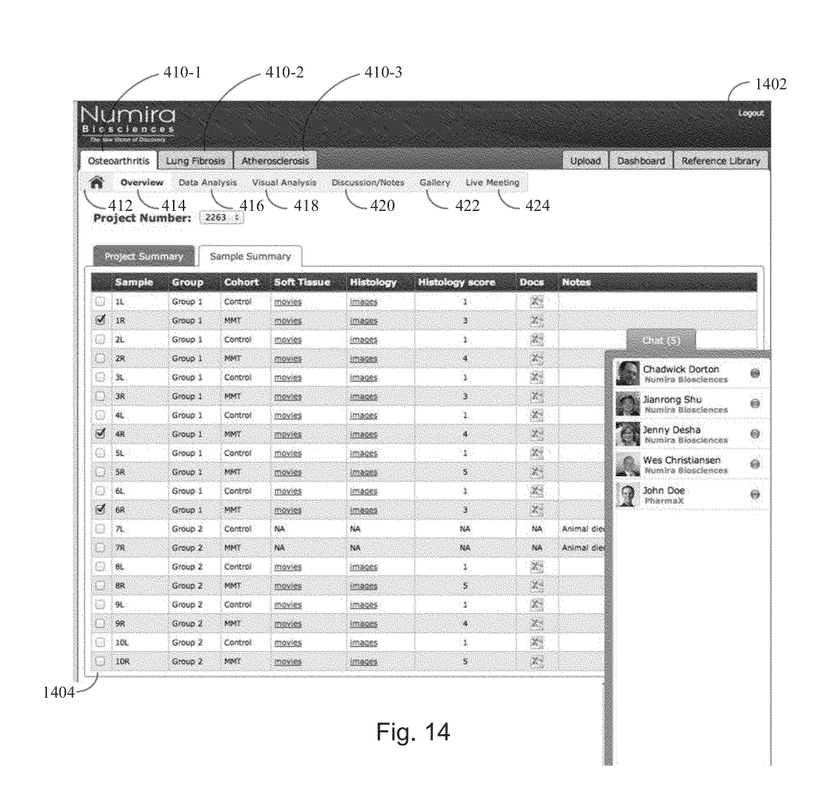

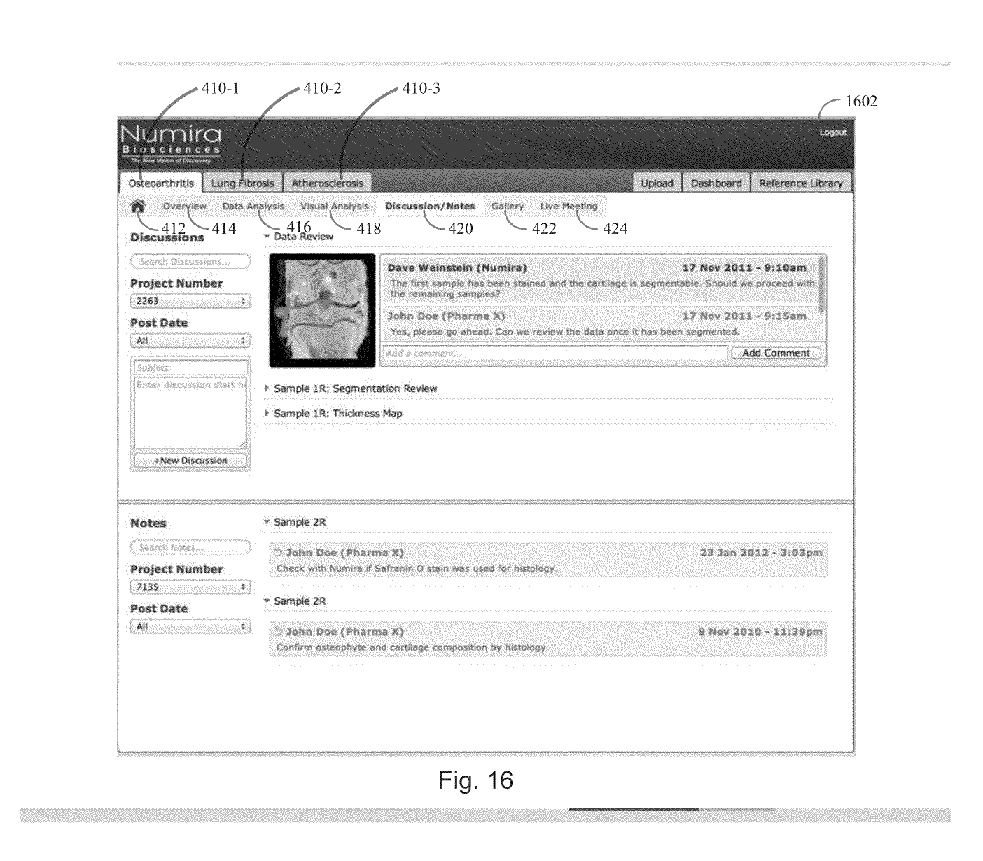

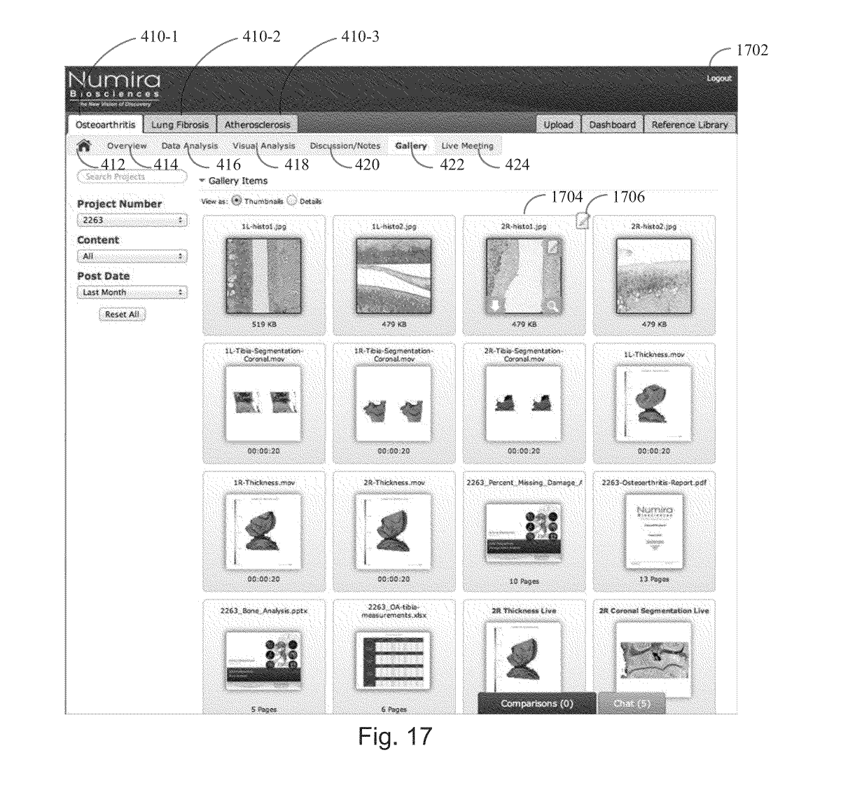

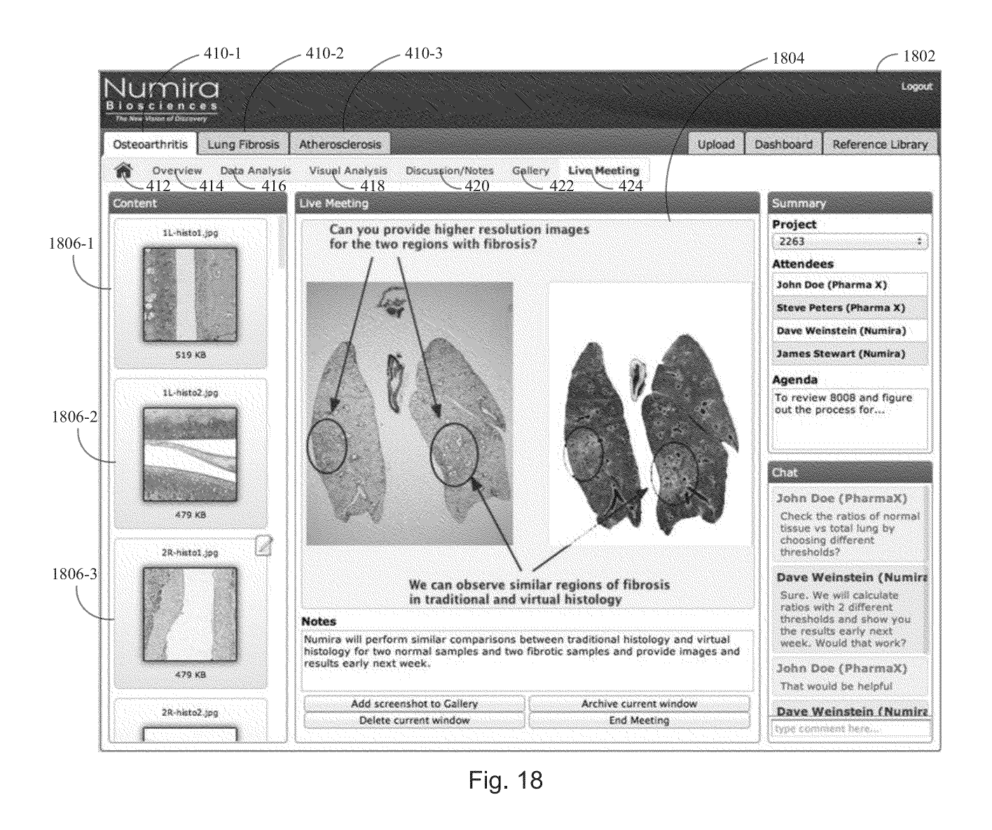

In some embodiments, each runtime system 46 comprises:
a home page module 50 which provides a home page panel, an example of which is the home page panel 402 illustrated in FIG. 4;
an overview module 52 which provides an overview panel for a selected project 410, an example of which is the overview panel 1402 illustrated in FIG. 14;
a data analysis module 54 which provides a data analysis panel for a selected project, and example of which is the data analysis panel 1202 illustrated in FIG. 12;
a visual analysis module 56 which provides a visual analysis panel for a selected project, an example of which is the visual analysis panel 502 illustrated in FIGS. 5-6;
a discussion/notes module 58 which provides a discussion/notes panel for a selected project, an example of which is the discussion/notes panel 1602 illustrated in FIG. 16;
a gallery module 60 which provides a gallery panel for a selected project, an example of which is the gallery panel 1702 illustrated in FIG. 17;
a live meeting module 62 which provides a live meeting panel for a selected project, an example of which is the live meeting panel 1802 illustrated in FIG. 18; and
a user information module 64 which provides information about each user (client) 66 of the runtime system 46 including, for each user 66, a user profile 68 that includes the user's access credentials; and
a project module 70 which tracks the projects hosted by the runtime system 46 and, for each such project, stores project information 72 including the location of databases associated with the project and the project category;
a plurality of applications 74, each application either being run within the virtual machine 42 or on a backend server 300;

As will be understood by one of skill in the art, there is individual nontransitory memory (e.g. of type 14) associated 1:1 with each virtual machine 42 residing on server 100. Such storage is where the virtual machine 42 operating systems and files are stored and accessed.

In practice, the hypervisor 40 initiates a virtual machine 42 on the server computer 100 and an operating system 44 is initiated within the initiated virtual machine 42. The hypervisor 40, also called a virtual machine manager (VMM), is any one of many hardware virtualization techniques that allow multiple operating systems 44 to run concurrently on the server computer 100. The hypervisor 40 presents to each of the guest operating systems 44 a virtual operating platform and manages the execution of such operating systems. Multiple instances of a variety of operating systems 44 may share the virtualized hardware resources. Commercial embodiments of the hypervisor 40 include, but are not limited to, OPENSTACK, EUCALYPTUS, VMWARE ESXI, CITRIX XENSERVER, MICROSOFT HYPER-V HYPERVISOR, SUN'S LOGICAL DOMAINS HYPERVISOR, and HP's INTEGRITY VIRTUAL MACHINES. Examples of operating systems 44 include, but are not limited to, UNIX, OPEN VMS, LINUX, and MICROSOFT WINDOWS. The runtime system 46 runs under the operating system 44 in a virtual machine 42.

Turning to FIG. 2, a local client system 200 will typically have one or more processing units (CPU's) 102, a network or other communications interface 104, a memory 114, a user interface 106 including a display 108 and keyboard 110, one or more communication busses 112 for interconnecting the aforementioned components, and a power supply 124 for powering the aforementioned components. The communication busses 112 may include circuitry (sometimes called a chipset) that interconnects and controls communications between system components. Memory 114 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 114 optionally includes one or more storage devices remotely located from the CPU(s) 2. Memory 114, or alternately the non-volatile memory device(s) within memory 114, comprises a non-transitory computer readable storage medium. Memory 114 can include mass storage that is remotely located with respect to the central processing unit(s) 102. In other words, some data stored in memory 114 may in fact be hosted on computers that are external to the local client system 200 but that can be electronically accessed by the client local system 200 over an Internet, intranet, or other form of network or electronic cable (illustrated as element 26 in FIG. 2) using network interface 104.

In some embodiments, Memory 114 stores an operating system 140 that includes procedures for handling various basic system services, a browser 142 for communicating with the runtime system 46, and user data 144 for uploading to the runtime system 46.

FIG. 2 further discloses one or more optional back-end servers 300. A back-end server 300 will typically have one or more processing units (CPU's) 202, a network or other communications interface 204, a memory 214, one or more communication busses 212 for interconnecting the aforementioned components, and a power supply 224 for powering the aforementioned components. The communication busses 212 may include circuitry (sometimes called a chipset) that interconnects and controls communications between system components. Memory 214 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 214 optionally includes one or more storage devices remotely located from the CPU(s) 2. Memory 214, or alternately the non-volatile memory device(s) within memory 214, comprises a non-transitory computer readable storage medium. Memory 214 can include mass storage that is remotely located with respect to the central processing unit(s) 202. In other words, some data stored in memory 214 may in fact be hosted on computers that are external to the back-end server 300 but that can be electronically accessed by the back-end server 300 over an Internet, intranet, or other form of network or electronic cable (illustrated as element 26 in FIG. 2) using network interface 204.

In some implementations, the memory 214 stores an operating system 240 that includes procedures for handling various basic system services and a communication module 242 for connecting to remote computers, such as server 100, over network 26. In some embodiments, memory 114 further stores one or more application programs 244 that are remotely accessed and controlled by an instance of a runtime system 46. In some embodiments, application programs 244 are run within virtual machines that are optionally running on the back-end server 300.

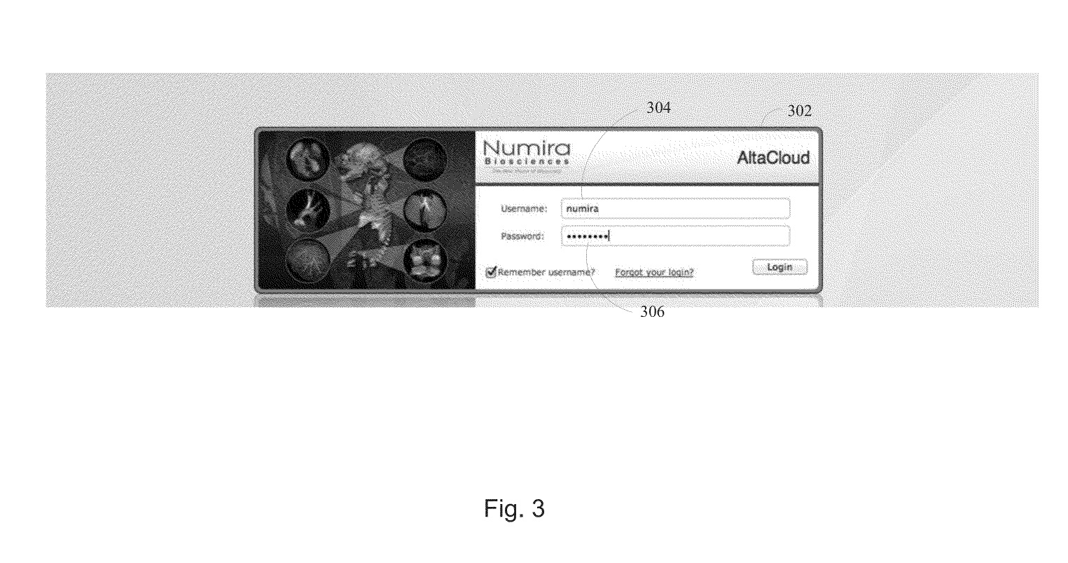

Now that an overview of a system topology 10 in accordance with an aspect of the present disclosure has been described, more details of an exemplary runtime system 46 will be disclosed. Referring to FIG. 3, the login screen 302 for a runtime system that facilitates project collaboration in a cloud computing environment is disclosed. In some embodiments, the projects are small animal imaging projects and the runtime system enables project members to manage those projects and the imaged specimen data associated with those projects in a cloud computing environment. When a user wants to go work with the various data sets of the projects that the user is associated with, the user logs into the runtime system by providing a login 304 and a password 306. Each user is associated with credentials. Thus, which aspects and functionality of the runtime system that the user will see when logged into the runtime system is completely dependent on the credentials associated with the user. Thus, if a user is not authorized to see certain data sets within a project, or entire projects hosted by the runtime system, the user will not be able to access such data or projects.

Turning to FIG. 4, an exemplary home page 402 for a user that used login screen 302 is disclosed. As seen in the home page 402 of the user that provided credentials in login page 302, the user is a member of (has credentials that allow the user to gain access to) three different project categories 410. For each respective project category, there is a corresponding tab 402 depicted on home page 402 that includes the name of the respective project category 410 associated with the tab. In the home page 402 depicted in FIG. 4, the user has access privileges to three different project categories 410: “Osteoarthritis”, “Lung Fibrosis”, and “Atherosclerosis”. Currently, as depicted in home page 402 of FIG. 4, the osteoarthritis project category is selected. Because the osteoarthritis project category is selected, the home page 402 provides an exemplary graphic 426 for the project category. Here, the exemplary graphic 426 is that of a knee joint. Moreover, the panel lists the projects 404 that are associated with the project category 410, provided that the user has access writes to the projects.

In panel 402, the projects 404 associated with the osteoarthritis project category are provided in an upper portion of the panel and, for each respective project 404 in the list, brief summary information 406, including direct links to most important documents. In the embodiment illustrated in FIG. 4, the brief summary information includes the species of tissue used for each project 404, the principle investigator of each project 404, the number of samples that have been processed in each project 404, when the project 404 initiated, when the project 404 ended or is projected to end, direct links to important documents associated with the project 404 and any notes associated with the project. Accordingly, exemplary panel 402 of FIG. 4 details that project 2263 is a rat study with 40 specimens. It started on Jan. 12, 2012. The project is currently in progress. Moreover, column 428 specifies that there is a document associated with project 2263. In other words, such documents are linked in. In the case of project 2263, the linked in document is a MICROSOFT POWERPOINT file. The user can download the POWERPOINT file to their local system and then open it up on their computer. Alternatively, the user can click on the file causing the file to execute directly from within the runtime system without ever having to download it specifically to the user's local system. In the case of MICROSOFT WORD, POWERPOINT AND EXCEL, the runtime system uses tools provided in the MICROSOFT Office software developer kit that allows for the exportation of images from each of the slides/pages of the document.

The runtime system compiles the images of a document associated with a project 408 into a view that is provided to the user when the user clicks on the file. In some embodiments, such images are prepared when the file is uploaded into the runtime or at some other time prior to receiving the request to view the document. When viewing the documents through the runtime system, the system provides controls to allow the user to toggle between the slides. Moreover, in some embodiments, the user can magnify portions of the screen. To support this feature, on the back end of the runtime system, when a document is processed, a high resolution and low resolution version of each of the pages of the document is created. When the user is viewing an entire image from the document, the low resolution version is shown and when the user is viewing a magnified portion of the image, the high resolution image is viewed.

Further provided in the home page 402 is an overview 430 of recent project activity (e.g. project updates, questions/discussions) 408 for each of the projects that the user has access to in the selected project category. Examples of project updates include messages that are sent out to each member of a project when triggering events occurs. Triggering events include, but are not limited to: (i) instances in which a member of a project annotates an object associated with a project (e.g. “John Doe (Pharm X) added a note to the hist_image ‘2R-histo1.jpg” for sample 2R”), samples associated with the project have been scanned, (iii) samples associated with the project have been processed, (iv) results for samples associated with the project have been added, (v) samples associated with the project have been received by a testing agency, and/or (vi) a signed purchase order has been received by the testing agency. In the runtime system, the recent activity in projects associated with the user is also available to registered users through push notifications, e-mails, etc. in some embodiments of the present disclosure.

Most of the messages in the overview of recent project activity are auto generated. So, for example, when a predetermined threshold amount of data has been processed (e.g., 30 percent), a project a message is automatically generated and sent to the recent activity panel 408. Project members are able to register for such messages or for different message types. Moreover, project members can specify within the runtime system how they want to be notified when different events happen. In other words, the user can select which types of messages they will receive and how they will receive such messages. So, for example, a user can specify that, whenever a project reaches fifty percent completion, they receive a text message alerting them to this fact. In another example, the user can specify that an e-mail is to be sent to the user whenever the processing lab has a question about particular data for a project on which the user works. Thus, the runtime system provides substantial flexibility on how message notifications are registered on the back end. The recent project activity 408 provides a list of all of the events that have transpired for the project in the selected project category 410.

The user can toggle to other views using the tabs below the project tabs. Selection of tab 412 leads to the home page panel, an example of which is illustrated in FIG. 4 and is discussed above. Selection of any one of tabs 414 through 424 leads to a panel associated with the project 410 that is currently selected. For instance, when the project 2263 of the project “Osteoarthritis” is selected, selection of any one of tabs 414 through 424 leads to a corresponding panel for project 2263. Selection of tab 414 leads to an overview panel for the selected project 410. An example of such an overview panel for the project 2263 is illustrated in FIG. 14. Selection of tab 416 leads to a data analysis panel for the selected project 410. An example of such a data analysis panel for the project 2263 of the project category “Osteoarthritis” is illustrated in FIG. 12. Selection of tab 418 leads to a visual analysis panel for the selected project 410. An example of such a visual analysis panel for the project 2263 is illustrated in FIGS. 5-6, 9, and 11. Selection of tab 420 leads to a discussion/notes panel for the selected project 410. An example of such a discussion/notes panel for the project 2263 is illustrated in FIG. 16. Selection of tab 422 leads to a gallery panel for the selected project 410. An example of such a gallery panel for the project 2263 is illustrated in FIG. 17. Selection of tab 424 leads to a live meeting panel for the selected project 410. An example of such a live meeting panel for the project 2263 is illustrated in FIG. 18.

FIG. 5 illustrates the panel 502 that is displayed by the runtime system when (i) the user selects the visual analysis tab 418, (ii) the project category 410-1 “Osteoarthritis” is selected, (iii) the user has selected project 2263, and (iv) the user selects the open project tab 430. Information associated with project 2263 is shown in panel 502. Panel 502 includes a plurality of object types 504 that are associated with the project. Advantageously, the runtime system supports many different object types 504 including, but not limited to, image types (e.g. two-dimensional imaging data, three-dimensional imaging data), movie types, and various application types. Moreover, the object types 504 that include badges 506 on panel 502 indicate that there are annotations for the data associated with such object types 504. Objects within the object types are active components that can be contracted and expanded directly from the runtime system.

The left-hand portion 508 of panel 502 lists out all of the specimens that are part of a project. Exemplary information for each specimen includes sample number, weight, type, dosage, necroscopy, and notes.

FIG. 6 illustrates panel 502 after a user has selected an object category 504-2 “planar movie(s)”. In this instance, an icon for each of the six planar movies 602 that are associated with project 2263 are displayed. When a user selects any of the icons for the movies, the movie corresponding to the selected icon is displayed directly from the runtime system.

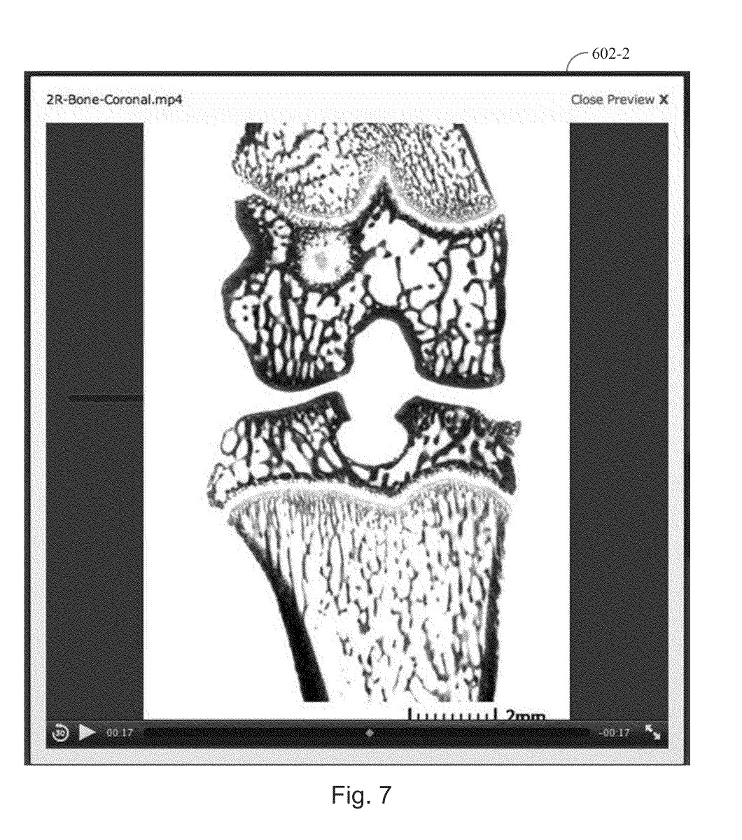

For instance, as illustrated in FIG. 7, the movie “2R-Bone-Coronal.mp4” is displayed when the user selects movie 602-2 in panel 502 of FIG. 6. Alternatively, as with any of the objects associated with a project, the user can download the movie to their local system for viewing or storage provided that user has sufficient privileges.

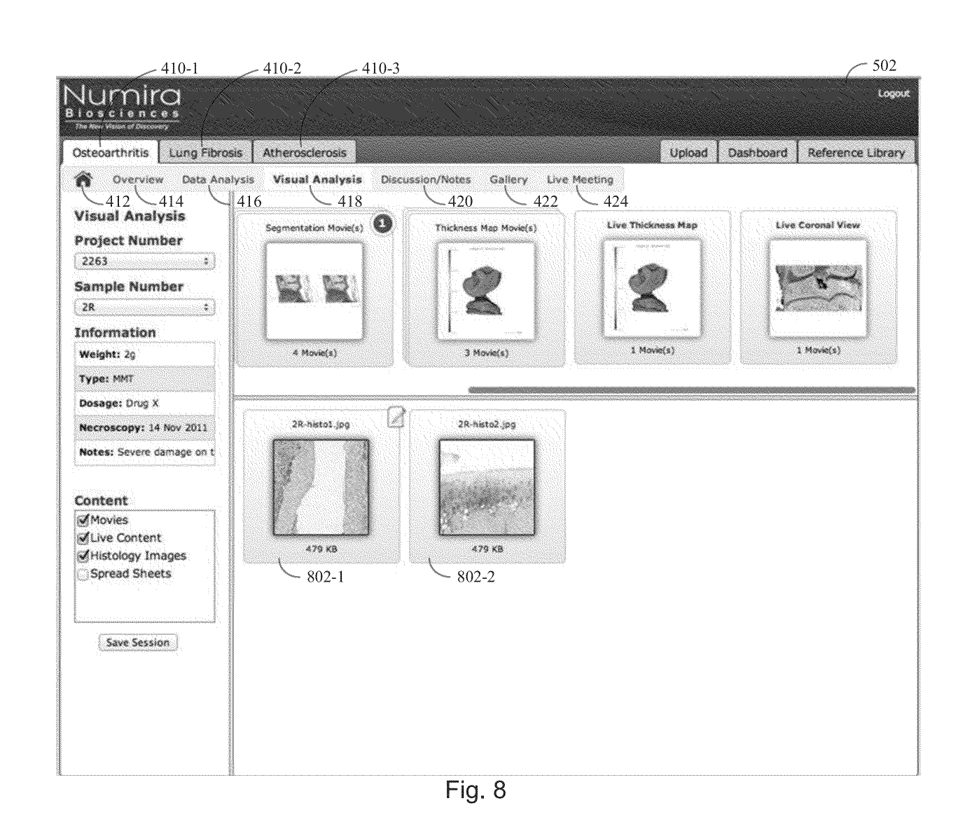

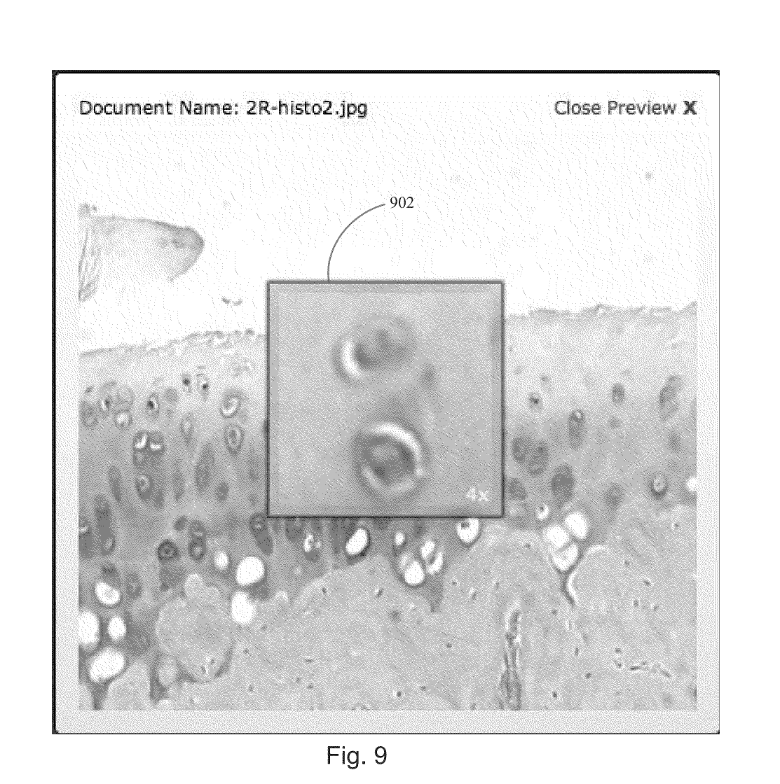

FIG. 8 illustrates panel 502 after a user has selected object category 504-2 “histology image(s)” from panel 502. In this instance, an icon 802 for each of the histological images that are associated with the selected object category 504-2 in project 2263 are displayed. When a user selects one of these images 802, the selected image is displayed directly from the runtime system using, for example, a JAVA plugin to the web browser running on the user's local system. For instance, as illustrated in FIG. 9, the image “2R-histo2.jpg” is displayed, at lower resolution, when the user selects image 802-2 in panel 502 of FIG. 8. Advantageously, as illustrated in FIG. 9, the runtime system provides the user with the option to use a magnifying box 902 to zoom into portions of the displayed histological image to view them at full resolution. This option is provided by the runtime system without any requirement that custom software be installed on the user's local system for looking at such images. Thus, using the runtime system, the user can quickly view the data without having to download such data and the applications needed to view the data.

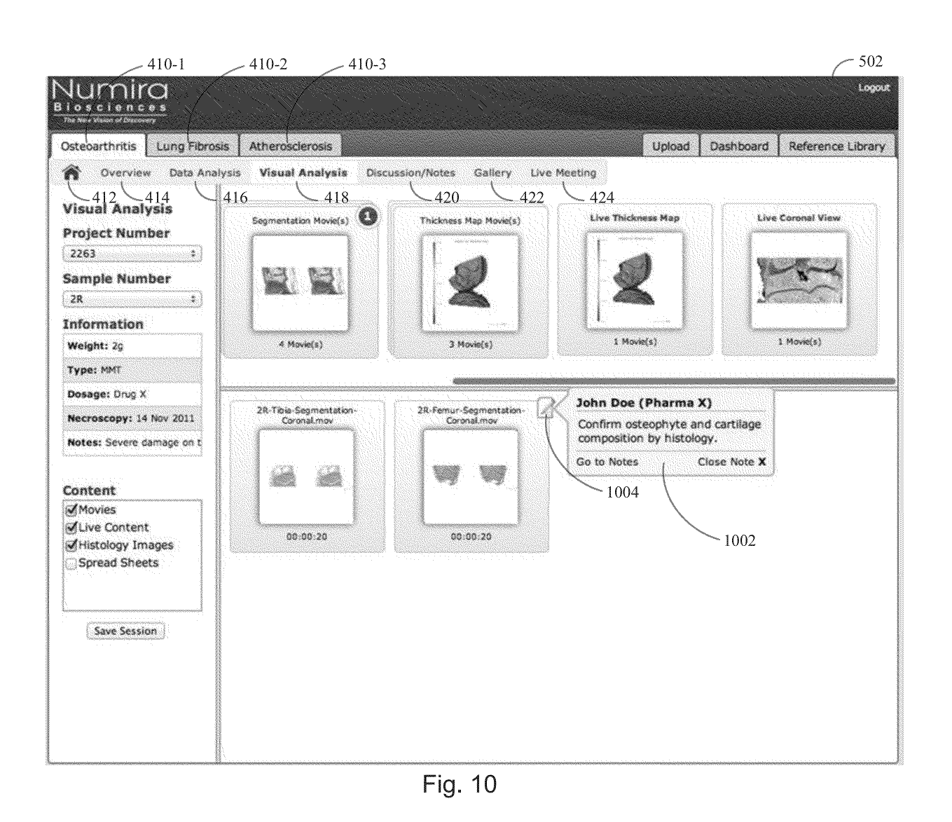

Turing to FIG. 10, the runtime system supports several object types 504 that can be made available as part of the visual analysis. As illustrated in FIG. 10, some of these object types include movies. Other object types include, but are not limited to, histological images and spreadsheets. As illustrated in FIG. 10, a user can use a notepad 1002 to annotate objects associated with the selected project. In some embodiments, once an object has been annotated, a note indicator 1004 is displayed next to the object to indicate that it has been annotated.

Advantageously, object types supported by the runtime system also include object types that are referred to herein as live (interactive) content. When an object that is in a live content category is selected, and the user requests that the live (interactive) object be run in its native software application, the object is run in native software running within the runtime system or on a back-end server that is in electronic communication with the runtime system. Advantageously, the object is immediately set to the appropriate view. Depending on the use case, the appropriate view can be a view of the object that was saved when a user associated with the project last viewed the object, a view of the object that was saved when the instant user last accessed the project, or some default view associated with the project.

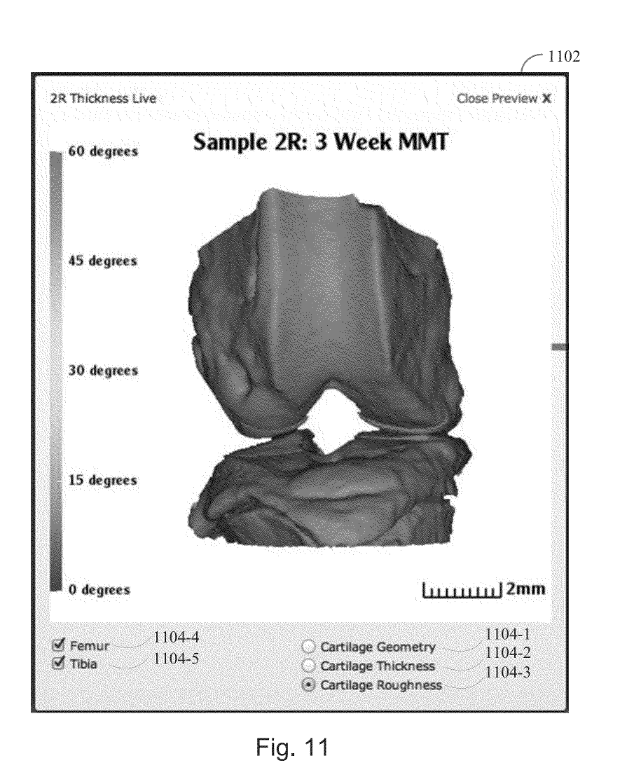

FIG. 11 shows a live object being run in live box 1102 using a rendering application without any requirement that the rendering software be installed on the user's local system. In other words, the visualization is controlled remotely from live box 1102. The user can rotate the data, zoom in and zoom out. The user can toggle on and off different features 1104. For instance, when the user is not interested in the femur and just want to see the tibia, the user deselect the femur using toggle 1104-4 and selects the tibia using toggle 1104-5. In FIG. 11, a roughness map is being shown because the user has selected toggle 1104-3, which controls cartilage roughage. The roughness map indicates the roughness of the surface. When the user wants to instead view a thickness map, the user deselects toggle 1104-3 and selects toggle 1104-2. The cartilage thickness is a different metric created and visualized on this data all in real time. A substantial amount of processing power and interactive visualization power are required to do this. However, because of the advantageous way that the runtime system is set up, such rendering is done without any requirement that the user set up the rendering software on their local system. The runtime system manages all of these calculations using one or more back-end servers that are in electronic communication with the runtime system. In some embodiments, instead of rendering images to a local display, the software driving the image illustrated in FIG. 11 renders the images to an off screen buffer. That buffer is then sent out over a socket to a communicating application that is then reading in that buffer. This provides the advantage of providing an interface this is highly customized. In alternative embodiments, the rending application is run on the back-end server and the relevant portion of the screen that corresponds to that application is captured and sent out over a socket to a communicating application that is then reading in that buffer. In some embodiments, the runtime system that produces the images depicted in FIGS. 3 through 18 is running in a first virtual machine and a rendering application that provides the live image illustrated in FIG. 11 is running in a second virtual machine. This second virtual machine is fired up when needed, for example when the user selects an object that is to be visualized in the rendering software, and then the second virtual machine shuts down when it is no longer needed, for example, because the user has terminated window 1102.

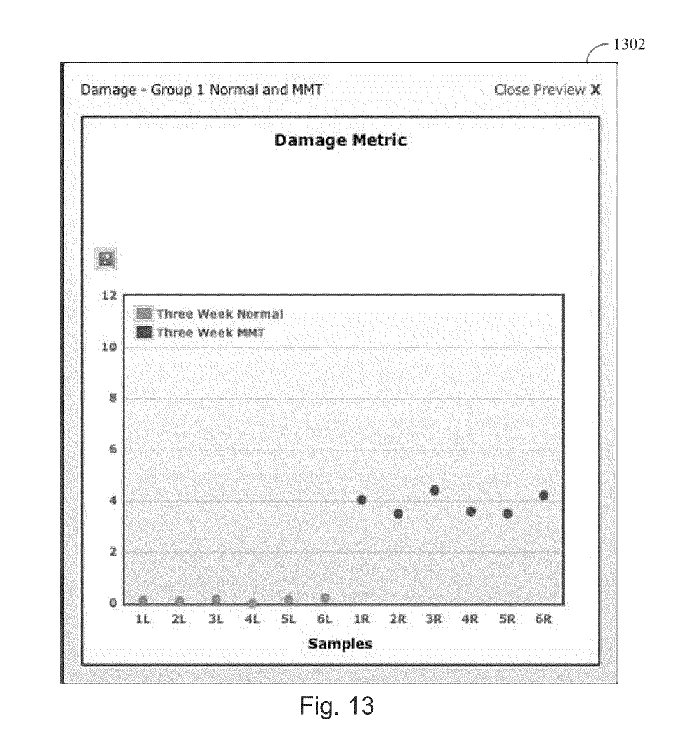

FIG. 12 illustrates the panel 1202 that is displayed by the runtime system when (i) the user selects the data analysis tab 416, (ii) the project category 410-1 “Osteoarthritis” is selected, and (iii) the user has selected project 2263. The statistics that have come out of project 2263 are detailed in panel 1202. Because this is an osteoarthritis project, the subject of the project is knee joints. More specifically, in this project the cartilage of the knee joint is of interest. As such, several different metrics related to this subject are disclosed. For instance, for each respective cartilage sample 1204 in the cartilage samples of project 2263, the surface area measurement 1206 of the respective cartilage sample, the volume 1208 of the respective cartilage sample, and an associated damage metric 1210 associated with the respective cartilage sample are disclosed. This data can be downloaded to a spreadsheet when the user clicks button 1212. Or the data can be sent by e-mail or printed out when similar buttons are selected. Referring to the right hand side of panel 1202, this data can also be plotted. Thus, instead of just looking at the data in a table view, a user can select a group of data and plot the data. For instance, consider the case in which the user is interested in group one in the group column 1214 and, in particular, the damage metric for group 1. The user clicks the add plot button 1216 after selecting group 1 using toggle button 1218 and the damage metric using toggle 1218. When this is done a plot 1220 is added to the plot gallery on the lower right portion of panel 1202, which contains all of the plots that the user has created. The user can change the toggle buttons and keep adding plots. The runtime system creates the plots on the fly in response to the user's requests. In some embodiments, the runtime system, operating in a virtual machine, uses the MICROSOFT developer kit to create the plot on the fly in response to user request and then turn the resulting plots into image. In this way, the user does not have to set up MICROSOFT EXCEL on their local system and import the data provided in the data analysis pane 1202. Moreover, the user can select on any of these plots, and the plot will expand out into a full size image. FIG. 13 show such a full size image 1302 created in this manner by the runtime system after the user has selected the image from the image gallery of data analysis panel 1202.

FIG. 17 illustrates the gallery panel 1702 that is displayed by the runtime system when (i) the user selects the gallery tab 422, (ii) the project category 410-1 “Osteoarthritis” is selected, and (iii) the user has selected project 2263. The gallery panel 1702 displays all of the content that is associated with the selected project and that this user has access to. In this instance, object histology image 1704 has associated annotation 1706. When such an annotation is created, subscribers to annotations of project 2263 would have been notified. The message would show up, for example, in overview 430 of panel 402 of FIG. 4. Turning to FIG. 17, users can also go back to annotation 1706 and see what date the annotation was created on and what was being considered when the annotation was created. Moreover, users can reply to the messages communicating the creation of such annotations using the discussions and notes page 1602 illustrated in FIG. 16. This feature is supported by extensive cross-linking in the runtime system when a data object gets created. Object record which users generated the object as well as other annotation information such as time stamps.

FIG. 18 illustrates the live meeting panel 1802 that is displayed by the runtime system when (i) the user selects the live meeting tab 424, (ii) the project category 410-1 “Osteoarthritis” is selected, and (iii) the user has selected project 2263. The live meeting panel 1802 is another way to view the data in the selected project. The live meeting panel 1802 is configured for collaboration among the members of a project. A user can use live meeting panel to present project data to other users in the project. Live meeting panel 1802 includes a white board 1804, which is a form of digital white board where the user can share objects associated with the project and the users can annotate such objects and talk about them. Moreover, the presenter can preload panel 1802 with select objects 1806 from the project in the left hand portion of panel 1802. During the presentation, a user can drag objects 1806 from the left hand portion of panel 1802 into the meeting. And then, any user that is participating in the meeting can annotate the objects 1806 that are on the whiteboard 1804 and ask questions. As the users are creating this meta data, database objects that track and store the metadata are getting created and stored and archived so that later on, at some point in the future, a user can go back to the meeting and remember who said what and what was agreed to during the presentation.

What is occurring during the presentation is that the context is being annotated, where the context is a session that is being shared by the users participating in the meeting. The context knows what images are part of it. So the annotation can follow the links and know which objects it refers to. Thus, the annotations are with respect to a context, where the context has component objects. So, for context, each object has an identifier and, for each object, the identifier stores a position and image size of the object on the white board 1804. For instance, the context knows that the object having object identifier A is placed at coordinates X, Y on the white board 1804 and that the object has an images size of H, W. Similarly, for each annotation in the context, the context stores the coordinates of the annotation on the white board 1804, the content of the annotation, and the size of the annotation. The live meeting panel 1802 shows one example of how other project members can be invited to share the presenting users screen. At any point when a first user is analyzing data in a project and discovers something interesting, the user can invite other users to see their session. The users can then discuss the finding and annotate selection object together.

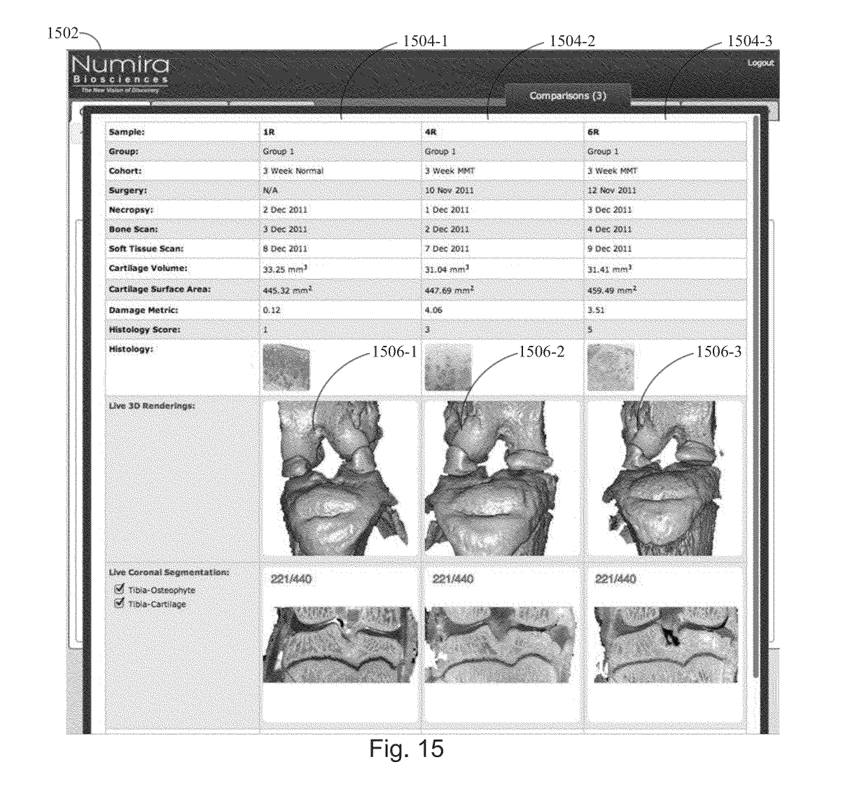

FIG. 14 illustrates the overview panel 1402 that is displayed by the runtime system when (i) the user selects the overview tab 414, (ii) the project category 410-1 “Osteoarthritis” is selected, and (iii) the user has selected project 2263. The user can use check boxes 1404 to select a number of specimens in the project. Here, in FIG. 14, the user has selected three specimens that the user finds of interest for some reason, 1R, 3R, and 5R. The user then clicks a comparison tab (not shown in FIG. 14) to launch an assessment comparison 1502, illustrated in FIG. 15, of the three specimens. The user can read down the columns 1504 to compare each specimen and all of the relevant information associated with the specimens. And in this view the user can also execute live interactive object. So if a user clicks on a live three dimensional rendering object 1506 in this view the rendering software that generated the three dimensional rendering will fire up three sessions of the software on the back end and the user will be able to compare the corresponding three dimensional object 1506 for each of the three specimens side-by-side. Moreover, the corresponding three-dimensional objects from each of the selected specimens will have synchronized camera views. When the user changes the three-dimensional viewing angle or scale of one of the objects, the corresponding objects will change their viewing angle or scale in an identical manner. In this way, the user can look for a particular feature of interest in all of the corresponding three dimensional objects at the same time and thus compare and contrast their features.

This feature of the runtime system is particularly advantageous. Such rendering software is complicated to run. Without the disclosed runtime system, the user would be faced with numerous obstacles, such as determining where the data sets are located, whether the latest version of the datasets and the rendering software is being used, and how to get previews side-by-side and synchronized as depicted in FIG. 15. With the disclosed runtime system, the user doesn't have to think about any of these task. The user simply goes to panel 1402, selects the specimens, and clicks on any of the live objects in the resulting panel 1502. Advantageously, the controls for viewing the live objects are intuitive and immediately responsive. Simple mouse commands, display touches, or keystroke commands permit the user to rotate and zoom the objects. The user does not have to think about any of the software complexities that drive the process.

Moreover, when viewing panel 1502, the user has the ability to pause the session and minimize the live three dimensional rendering session back to a graphic in which the state of the rendering is saved. In other words, the runtime system will track exactly what state the renderings were in when the user shut down the renderings so that the next time the user click on an object 1506, the runtime system will take the user right to the state the renderings were in when the user last accessed the objects. Thus, the state is saved with all of the live sessions.

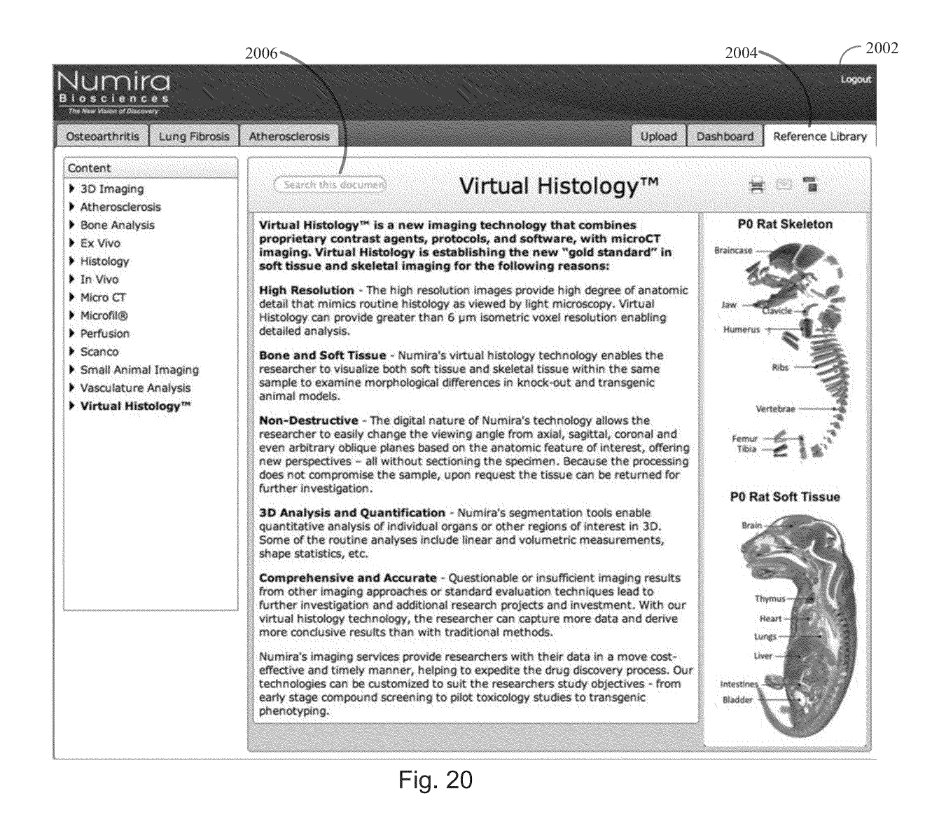

Referring to FIG. 20, the runtime system provides a reference library panel 2002 that is accessed when the user selects tab 2004 from the home page 402. The reference library provides information on the techniques that are used to image data in the various projects supported by the runtime system. In some embodiments, the information provided in panel 2002 is Wikipedia-style information about imaging, including VIRTUAL HISTOLOGY™, and how such techniques work. User can review panel 2002 to see what the servicing laboratory does with project samples. The user can also use table 2006 to access full search capabilities across the information provided through the reference library panel 2002.

In some embodiments, the reference library panel 2002 is cross linked to other databases such as PubMed, Wikipedia, and genome databases. As such, the reference library panel 2002 provides a way to gather information relevant to the various projects supported by the runtime system through one interface.

Another component that is provided in the reference library system 2002 is exemplary specimens. Such exemplary specimens are typically not associated with any of the projects supported by the runtime system but rather are provided to show the capabilities of the imaging techniques used by the laboratory that scans and processes the specimens in the projects that are supported by the runtime system. For example, consider the case in which a user wants to review the exemplary specimens to determine whether the laboratory that processes the specimens used in the various projects supported by the runtime system is capable of visualizing cardiac defects in specimens. In this instance, the user can review the exemplary cardiac data sets provided through library panel 2002 to assess whether the laboratory has such a capability. In some embodiments, library panel 2002 provides such exemplary data sets, as well as segmentations and analyses of such data sets available for any user of the runtime system. In some embodiments, library panel 2002 provides such exemplary data sets, as well as segmentations and analyses of such data sets available to only those users of the runtime system who have sufficient access privileges. In some embodiments, library panel 2002 provides such exemplary data sets, as well as segmentations and analyses of such data sets available for only those users who have paid a subscription or other form of access fee to review such data.

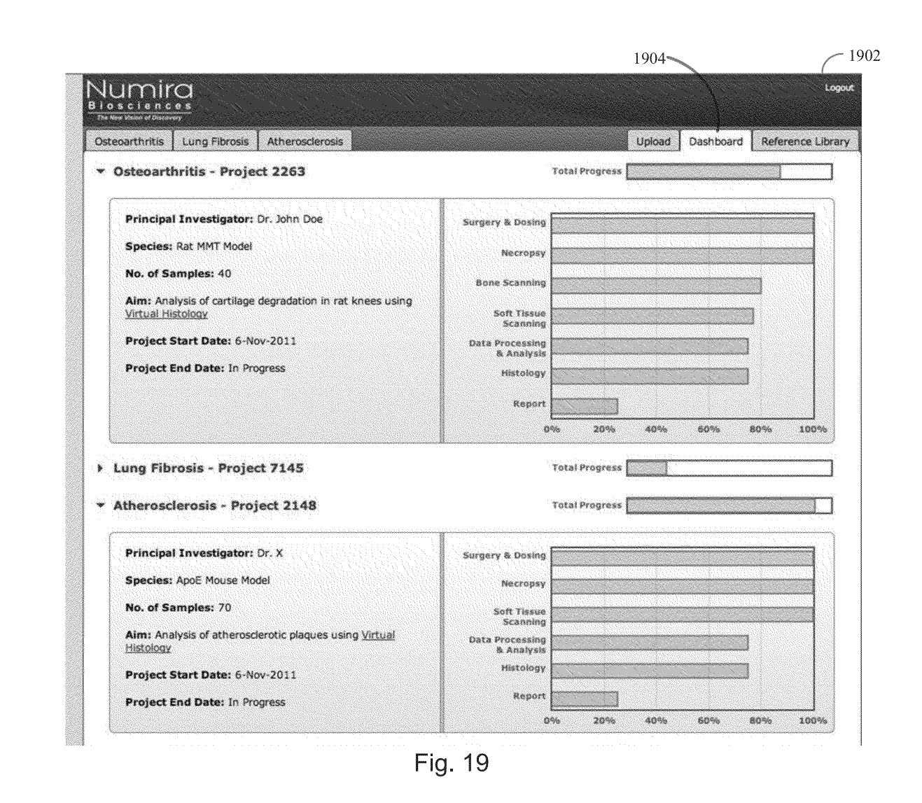

Referring to FIG. 19, the runtime system provides a dashboard view panel 1902 that is accessed when the user selects tab 1904 from the home page 402. A user can review the dashboard view panel to see the stages of different components of the projects associated with the user. In some embodiments, the percent completion of each stage of the projects is shown. The dashboard view panel 1902 is useful for users that are managers that want to see how far along things are on their projects.

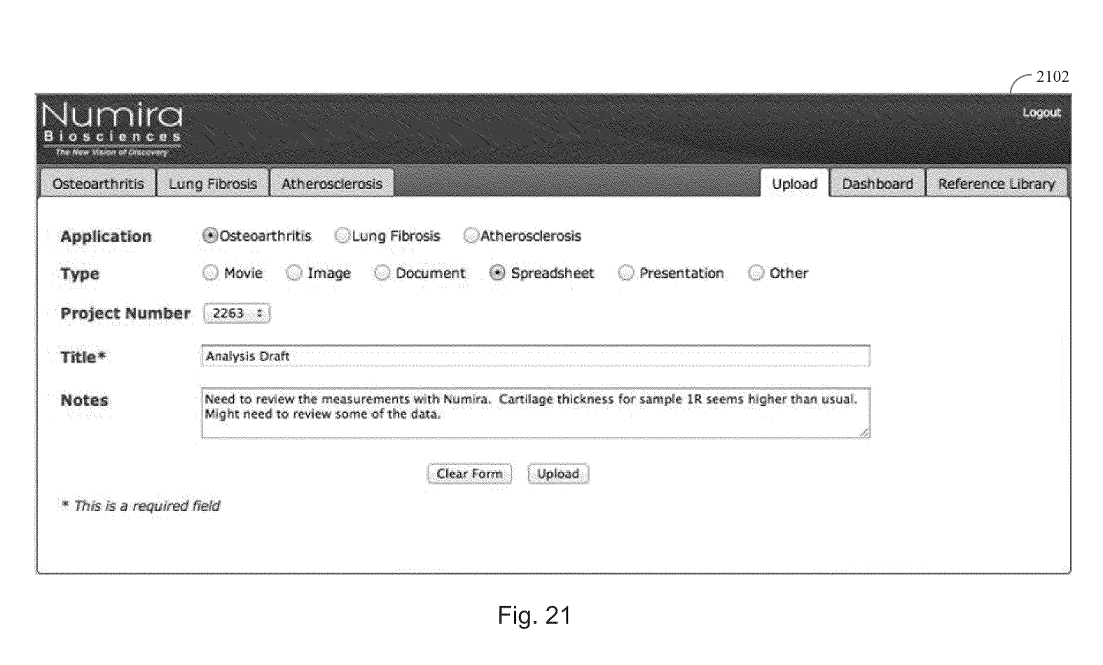

Referring to FIG. 21, the runtime system provides an upload module 2102 that is accessed when the user selects tab 2104 from the home page 402 (FIG. 4). Users can use the upload module 2102 to upload their own movies and images and documents into the runtime system. The upload module 2102 allows for instances where users are collaborating amongst themselves rather than simply reviewing data set that were logged into the system by a laboratory that services specimens provided by the user. For instance, consider the case in which a company that subscribes to and uses the runtime system have five different researchers each of whom sign on and review data sets, share annotations, and use the other services provided by the runtime system. In this instance, the runtime system provider would not have access to data that the five different researcher upload. Data that such users upload would go into associated with the subscribing company and unless a user is a database administrator with access to the database, others including the runtime system administrator, cannot see the data. In this way, users of the runtime system are ensured that their data is secure in the same way as their internal documents and internal applications at their site. All accesses to the user's database by any user are authenticated and logged. The users know whenever their private data has been accessed and password is regenerated when a user loses their password. In the rare instance where the runtime system must use a client's administrative access key, the client will be informed.

For clients leading a GLP (Good Laboratory Practices) study, the runtime system 46 follows and adheres to GLP guidelines and regulations to withstand scrutiny from a potential FDA audit.

### EXEMPLARY EMBODIMENTS

In some implementations, a cloud based server computer system includes: one or more remotely located servers that store and run multiple software programs; at least one computer device capable of accessing the Internet; and an application accessible to multiple users through a user's internet web browser that allows for a user to access the multiple software programs without requiring the user to download any software program onto the user's computer; where the application is designed to facilitate a user's evaluation of the software programs.

In some implementations, the cloud based server computer system is configured to allow the user to upload test datasets to interact with the software programs.

In some implementations, in the cloud based server computer system described above, the application is accessible through the user's computer or mobile device capable of accessing the Internet.

In some implementations, the cloud based server computer system is configured to enable multiple users to access the same software programs concurrently.

In some implementations, a data storage and analysis cloud-based server computer system comprises: one or more remotely located servers that store a user's data and multiple software programs capable of processing and analyzing the data; at least one computer device capable of accessing the internet; and an application accessible to multiple users through a user's internet web browser that allows for a user's data stored on the remote server to be processed and analyzed using at least one software program stored on the remote server without requiring the user to download the data or any software program onto the user's computer.

In some implementations, the application allows at least two users to concurrently communicate, manipulate data, or visualize datasets.

In some implementations, the application allows for a user to login to the application using a unique login name and password associated with only one user.

In some implementations, the application associates data sets with a particular user based upon the unique login name and password provided by the user.

In some implementations, the application organizes a user's data into projects and a home page that provides details of a plurality of projects associated with a user.

In some implementations, the application further comprises an overview panel for a project selected from the plurality of projects.

In some implementations, the application further comprises a data analysis panel for the selected project, the data analysis panel comprising a plurality of measurements for each sample in the plurality of samples associated with the project.

In some implementations, the application further comprises a visual analysis panel for the selected project, the visual analysis panel including a plurality of objects associated with the selected project.

In some implementations, the application further comprises a gallery panel for the selected project, for reviewing content that is associated with the selected project.

In some implementations, the application further comprises a live meeting panel for a selected project, where the live meeting panel comprises a whiteboard that is configured to be viewed by any user associated with the selected project, and where any user associated with the project that is viewing the whiteboard can drag objects associated with the selected project onto the whiteboard and can annotate the whiteboard.

In some implementations, the application further comprises a real time tracking system to track the status of samples being processed by the first user.

In some implementations, the data comprises volumetric imaging datasets that can be viewed in both two-dimensional and three-dimensional visualizations using at least one software program stored on the remotely located servers.

In some implementations, the application allows for the user to interact and view the data through a desktop computer or a mobile device.

In some implementations, the application allows for the user to select multiple data inputs and view the data in side-by-side comparison.

In some implementations, the server computer system further comprises metadata tags to encode information about how a project dataset was created.

In some implementations, the application allows for the user to input annotations that are saved on the remotely located servers.

In other implementations, a collaborative, cloud-based data storage and analysis system comprises: one or more remotely located servers that store a user's data and multiple software programs capable of processing and analyzing the data; at least one computer device capable of accessing the internet; an application accessible to multiple users through a user's internet web browser that allows for a user's data stored on the remote server to be processed and analyzed using at least one software program stored on the remote server without requiring the user to download the data or any software program onto the user's computer; where the application tightly couples the software programs as needed by the user for seamless integration; where the application can be accessed by multiple users simultaneously; where the application facilitates computing derived values from the original data; where the application facilitates exploration and analysis of the data; where the application can be accessed using various operating systems; and where the user's data can be searched or filtered by the application.

In some implementations, the application further comprises any combination of two or more of features (i) through (iv): (i) the application tracks which user accesses the data and records the time and date of access; (ii) the application records and stores provenance data, which encodes the applications and parameters that were used in creating a dataset; (iii) the application comprises an electronic laboratory notebook for the user to store data, computations, annotations, or communications; and (iv) multiple users of the system can collaboratively explore data together in real time.

In some implementations, the application further comprises all of the following features: (i) the application tracks which user accesses the data and records the time and date of access; (ii) the application records and stores provenance data, which encodes the applications and parameters that were used in creating a dataset; (iii) the application comprises an electronic laboratory notebook for the user to store data, computations, annotations, or communications; and (iv) multiple users of the system can collaboratively explore data together in real time.

In some implementations, the collaborative, cloud-based data storage and analysis is used in a scientific or engineering industry.

In some implementations, the collaborative, cloud-based data storage and analysis is used in the life science industries.

In some implementations, the collaborative, cloud-based data storage and analysis is used for preclinical pharmaceutical development.

In some implementations, the collaborative, cloud-based data storage and analysis is used for medical device development.

### REFERENCES CITED AND ALTERNATIVE EMBODIMENTS

All references cited herein are incorporated herein by reference in their entirety and for all purposes to the same extent as if each individual publication or patent or patent application was specifically and individually indicated to be incorporated by reference in its entirety for all purposes.

The embodiments disclosed herein can be implemented as a computer program product that comprises a computer program mechanism embedded in a tangible computer readable storage medium. For instance, the computer program product could contain the program modules shown in FIGS. 1 and/or 2. These program modules can be stored on a CD-ROM, DVD, magnetic disk storage product, or any other nontransitory computer readable data or program storage product.

Many modifications and variations of the embodiments disclosed herein can be made without departing from its spirit and scope, as will be apparent to those skilled in the art. The specific embodiments described herein are offered by way of example only. The embodiments were chosen and described in order to best explain the principles of the present disclosure and its practical applications, to thereby enable others skilled in the art to best utilize the present disclosure and various embodiments with various modifications as are suited to the particular use contemplated. The present disclosure is to be limited only by the terms of the appended claims, along with the full scope of equivalents to which such claims are entitled.

What is claimed:

1. A method, comprising:
at a computer system,
hosting a collaboration software application and a plurality of data sets associated with the collaboration software application;
establishing a first remote user session between the computer system and a first client device running on a first operating system; wherein the first client device is associated with a first user;
establishing a second remote user session between the computer system and a second client device running on a second operation system, distinct from the first operating system;
wherein the second client device is associated with a second user distinct from the first user;
merging the first remote user session and the second remote user session into a single remote user session; and
enabling, using the single remote user session, the first user and the second user to concurrently control the collaboration software application and the plurality of data sets.

2. The method of claim 1, wherein the collaboration software application comprises a whiteboard application, and the plurality of data sets includes one of: audio files, video files, image files, 3D images, charts, tables, or data grids.

3. The method of claim 1, wherein the plurality of data sets comprises histology data sets.

4. The method of claim 2, further comprising: preparing for concurrent display from a plurality of angles, a three-dimensional object represented in a three-dimensional image.

5. The method of claim 4, further comprising: adjusting a display of the three dimensional object from a first angle in the plurality of angles, without user intervention, in accordance with a change to a display of the three dimensional object from a second angle in the plurality of angles.

6. The method of claim 1, further comprising: preparing for display, in the collaboration application, status indicators for the first and second users.

7. The method of claim 1, further comprising: enabling the first and second users to concurrently access a plurality of projects using the collaboration software application.

8. The method of claim 7, further comprising: preparing for display a representation of a count of users having access to a project in the plurality of projects.

9. The method of claim 1, further comprising: preparing for concurrent display a data set in the plurality of data sets in a first visual representation, and a second visual representation distinct from the first visual representation.

10. The method of claim 9, wherein the first visual representation is a grid view, and the second visual representation is a chart view.

11. The method of claim 1, further comprising: recording access history for a respective user in the first or second user.

12. The method of claim 1, further comprising: obtaining an update to the plurality of data sets, and in response to the update, preparing for display, to the first and second users, a second plurality of data sets in accordance with the first plurality of data sets and the update.

13. A computer system comprising:
one or more processing units;
one or more programs including instructions, configured to be executed by the one or more processing units, for:
hosting a collaboration software application and a plurality of data sets associated with the collaboration software application;
establishing a first remote user session between the computer system and a first client device running on a first operating system; wherein the first client device is associated with a first user;
establishing a second remote user session between the computer system and a second client device running on a second operation system, distinct from the first operating system; wherein the second client device is associated with a second user distinct from the first user;
merging the first remote user session and the second remote user session into a single remote user session; and
enabling, using the single remote user session, the first user and the second user to simultaneously control the collaboration software application and the plurality of data sets.

14. The system of claim 13, wherein the collaboration software application comprises a whiteboard application, and the plurality of data sets includes one of: audio files, video files, image files, 3D images, charts, tables, or data grids.

15. The system of claim 13, wherein the plurality of data sets comprises histology data sets.

16. The system of claim 14, wherein the one or more programs further comprise instructions for:
preparing for concurrent display from a plurality of angles, a three dimensional object represented in a three-dimensional image.

17. The system of claim 16, wherein the one or more programs further comprise instructions for:
automatically adjusting a display of the three dimensional object from a first angle in the plurality of angles, without user intervention, in accordance with a change to a display of the three dimensional object from a second angle in the plurality of angles.

18. The system of claim 13, wherein the one or more programs further comprise instructions for:
preparing for display, in the collaboration application, status indicators for the first and second users.

19. The system of claim 13, wherein the one or more programs further comprise instructions for:
enabling the first and second users to concurrently access a plurality of projects using the collaboration application.

20. The system of claim 19, wherein the one or more programs further comprise instructions for:
preparing for display a representation of a count of users having access to a project in the plurality of projects.

21. The system of claim 13, wherein the one or more programs further comprise instructions for:
preparing for concurrent display a data set in the plurality of data sets in a first visual representation, and a second visual representation distinct from the first visual representation.

22. The system of claim 21, wherein the first visual representation is a grid view, and the second visual representation is a chart view.

23. The system of claim 13, wherein the one or more programs further comprise instructions for:
recording access history for a respective user in the first or second user.

24. The system of claim 13, wherein the one or more programs further comprise instructions for:
obtaining an update to the plurality of data sets, and in response to the update, preparing for display, to the first and second users, a second plurality of data sets in accordance with the first plurality of data sets and the update.

25. A non-transitory computer readable storage medium storing one or more programs, the one or more programs comprising instructions, configured to be executed by a computer system with one or more processors, for:
hosting a collaboration software application and a plurality of data sets associated with the collaboration application;
establishing a first remote user session between the computer system and a first client device running on a first operating system; wherein the first client device is associated with a first user;
establishing a second remote user session between the computer system and a second client device running on a second operation system, distinct from the first operating system;
wherein the second client device is associated with a second user distinct from the first user;
merging the first remote user session and the second remote user session into a single remote user session; and
enabling, using the single remote user session, the first user and the second user to concurrently control the collaboration software application and the plurality of data sets.

26. The non-transitory computer readable storage medium of claim 25, wherein the collaboration software application comprises a whiteboard application, and the plurality of data sets includes one of: audio files, video files, image files, 3D images, charts, tables, or data grids.

27. The non-transitory computer readable storage medium of claim 25, wherein the plurality of data sets comprises histology data sets.

28. The non-transitory computer readable storage medium of claim 26, wherein the one or more programs further comprise instructions for: preparing for concurrent display from a plurality of angles, a three-dimensional object represented in a three-dimensional image.

29. The non-transitory computer readable storage medium of claim 28, wherein the one or more programs further comprise instructions for: automatically adjusting a display of the three dimensional object from a first angle in the plurality of angles, without user intervention, in accordance with a change to a display of the 3D object from a second angle in the plurality of angles.

30. The non-transitory computer readable storage medium of claim 25, wherein the one or more programs further comprise instructions for: preparing for display, in the collaboration application, status indicators for the first and second users.

31. The non-transitory computer readable storage medium of claim 25, wherein the one or more programs further comprise instructions for: enabling the first and second users to concurrently access a plurality of projects using the collaboration application.

32. The non-transitory computer readable storage medium of claim 31, wherein the one or more programs further comprise instructions for: preparing for display a representation of a count of users having access to a project in the plurality of projects.

33. The non-transitory computer readable storage medium of claim 25, wherein the one or more programs further comprise instructions for: preparing for concurrent display a data set in the plurality of data sets in a first visual representation, and a second visual representation distinct from the first visual representation.

34. The non-transitory computer readable storage medium of claim 33, wherein the first visual representation is a grid view, and the second visual representation is a chart view.

35. The non-transitory computer readable storage medium of claim 25, wherein the one or more programs further comprise instructions for: recording access history for a respective user in the first or second user.

36. The non-transitory computer readable storage medium of claim 25, wherein the one or more programs further comprise instructions for: obtaining an update to the plurality of data sets, and in response to the update, preparing for display, to the first and second users, a second plurality of data sets in accordance with the first plurality of data sets and the update.
